(19) United States
(12) Patent Application Publication
(10) Pub. No.: US 2011/0246811 A1
(43) Pub. Date: Oct. 6, 2011

(54) METHOD FOR ESTIMATING THE RELIABILITY OF AN ELECTRONIC CIRCUIT, CORRESPONDING COMPUTERIZED SYSTEM AND COMPUTER PROGRAM PRODUCT

(75) Inventors: Josep Torras Flaquer, Grenoble (FR); Jean-Marc Daveau, Grenoble (FR); Lirida Naviner, Le Blanc-Mesnil (FR); Philippe Roche, Biviers (FR)

(73) Assignees: STMicroelectronics SA, Montrouge (FR); Centre National de la Recherche Scientifique (CNRS)

(21) Appl. No.: 13/074,204

(22) Filed: Mar. 29, 2011

(30) Foreign Application Priority Data
Mar. 30, 2010 (FR) 1052328

(51) Int. Cl. G06F 11/00

(52) U.S. Cl. 714/1; 714/E11.02

(57) ABSTRACT

The determination of a reliability guideline of an electronic circuit having a nodal network of components including at least one reconvergence path between a correlation source and a sink, involves at the level of each component of the path, a computation of a conditional probability matrix whose conditioning is related to at least one node of the path situated upstream of the component.

### FIELD OF THE INVENTION

The invention relates to electronic circuits, especially logic circuits, and, more particularly, to the estimation of their reliability.

### BACKGROUND OF THE INVENTION

The reliability of an electronic circuit may be defined as the probability that the circuit executes the right operation in the presence of a predetermined set of conditions. The reliability of a logic circuit may moreover be defined as being the probability that its output signal or signals are correct with respect to one or more input signals.

The reliability of an electronic circuit becomes all the more crucial as the size of circuits decreases through the use of advanced technologies, for example CMOS technologies of below 45 nanometres. Indeed, the smaller the components of the electronic circuit, the more sensitive they are to environmental factors, this of course having an impact on the reliability of the circuit.

It is therefore particularly beneficial to be able to estimate the reliability of an electronic circuit, in particular a logic circuit. Several approaches have been envisaged hitherto for estimating the reliability of a logic circuit.

A first approach, known by those skilled in the art as the “global PTM approach”, is based on the use of probabilistic transfer matrices (PTM Matrices: Probability Transfer Matrices) associated with the various types of components of the circuit.

More precisely, for each type of component of the circuit, it is possible to define an Ideal Transfer Matrix termed the “ITM matrix” and a PTM matrix. Each of these matrices contains the probabilities of getting a state for the output signal with respect to a given state of the input signal or signals of the component.

For a component of the combinatorial type, such as a logic gate, the ITM matrix contains 1s and 0s and is deduced from the truth table of the logic component. The latter is then assumed to be perfect, that is to say not producing any error.

On the other hand, in the PTM matrix, the values of the probability of getting a state at output for a given state of one or more inputs take account of probabilities of errors inherent to the components and related in particular to the technology used, and also to the manner of producing the said component.

The obtaining of a PTM matrix for a type of component is well known to those skilled in the art and such a PTM matrix is one of the elements characterizing such a component.

By way of indication, numerous technological parameters may be used to estimate the probabilities of errors of the components and consequently to obtain the PTM matrices associated with these components. In this regard, those skilled in the art will be able to refer for all useful purposes to the article by Tanay Karnik and others entitled: “Characterization of Soft Errors Caused by Single Event Upsets in CMOS Processes” IEEE Transactions on Dependable and Secure Computing, Vol. 1, No. 2, pages 128-143, April-June 2004.

On the basis thereof, the so-called “global PTM” procedure includes obtaining a global matrix of the PTM type through a successive combination of the elementary PTM matrices of the components as a function of the parallel or series connection of the components within the circuit. Next, by convolving a probability matrix representative of the states of an input signal with this global PTM matrix, a probability matrix representative of the states of the output signal of the circuit is obtained, on the basis of which the reliability guideline can be obtained.

However, a global PTM procedure such as this remains a theoretical procedure. Indeed, as soon as the number of inputs and outputs of the electronic circuit, and consequently the number of components interconnected between these inputs or these outputs, becomes significant, the size of the global PTM matrix becomes gigantic, thereby leading to saturation of the memory of the computer used to implement this procedure. Moreover, the calculation time required to obtain the reliability guideline is considerable.

To obtain an acceptable calculation time and an acceptable memory size, it has thus been envisaged that a procedure termed SPR (Signal Probability Reliability) be used, which does not calculate a global matrix but which uses a probabilistic propagation approach by gradually calculating, that is to say component after component, probability matrices. The probability matrices contain the probabilities of the states of the output signal of each component on the basis of matrix operations involving probability matrices (termed SPR matrices) for the signals present at the input of the component and by also using the PTM matrix and the ITM matrix for this component.

More precisely, a logic signal, be it an input logic signal of the circuit, an intermediate logic signal internal to the circuit, or else an output signal of the circuit, is represented by a probability matrix of size 2×2 containing the probability of the occurrence of a correct “0” logic value of the signal, the probability of the occurrence of a correct “1” logic value of the signal, the probability of the occurrence of an incorrect “0” logic value of the signal, and the probability of an incorrect “1” logic value of the signal.

An incorrect “0” logic value is a value which ought to be a “1” under a normal operating condition, that is to say a condition devoid of error. Likewise, an incorrect “1” logic value is a value which ought to be “0” under a condition devoid of error.

The logic signal is consequently represented by four states to which probability values are assigned and which define the matrix termed the SPR matrix. However, this SPR procedure gives an exact result in the absence of correlated signals affecting the same component inside the electronic circuit. Indeed, the determination of a probability matrix of an output signal of a component on the basis of the probability matrices of the input signals of this component is exact if the input signals are independent.

If these signals are correlated by at least one correlation source, then the calculation of the output SPR matrix of the component is not exact. Now, an electronic circuit not generating any correlated signal within it generally pertains to an academic case. Indeed, electronic circuits produced industrially generally exhibit a significant number of correlation sources and consequently generate numerous correlated signals.

In order to take these correlated signals into account, it has thus been envisaged that the SPR procedure be used in several successive passes for the electronic circuits exhibiting correlation sources. This procedure is commonly designated by those skilled in the art as the “multi-pass SPR procedure.”

More precisely, by considering that each signal arising from a correlation source has four possible states, the “multi-pass SPR” procedure will include applying the SPR procedure to the entire circuit, successively for each of the states of each signal arising from each correlation source. A reliability guideline will then be obtained at each pass. The weighted sum of the reliability guidelines which is obtained on completion of the passes then provides the reliability guideline for the electronic circuit.

It is immediately noted that the number of executions of the SPR procedure is here equal to 4^{m} where m denotes the number of correlation sources. Now, in reality electronic circuits exhibit numerous correlation sources, thus consequently leading to a combinatorial explosion and an extremely significant calculation time required to ultimately obtain a guideline regarding the reliability of the circuit. This “multi-pass SPR” procedure consequently remains industrially unutilizable for electronic circuits of very large size, exhibiting for example a nested and complex architecture with several tens of inputs and several tens of outputs.

### SUMMARY OF THE INVENTION

According to one mode of implementation, there is a method for estimating the reliability of an electronic circuit making it possible to obtain an exact or quasi-exact reliability guideline (for PTM matrices and given input signals) of an electronic circuit comprising numerous correlation sources generating correlated signals, while considerably reducing the calculation time and also reducing the necessary memory size of the computerized system implementing this method.

According to one mode of implementation it is proposed that a reliability guideline of an electronic circuit comprising a nodal network of components comprising at least one so-called “reconvergence” path between a correlation source and a sink be determined by using, for example, at the level of each component of the path a conditional probability matrix whose conditioning is related to at least one node of the path situated upstream of the said component.

According to one aspect, there is thus proposed a method for estimating the reliability of an electronic circuit, the electronic circuit comprising a network of interconnected nodes at the level of at least some of which are placed components. This method is implemented within a computerized system and comprises a global processing based on a probabilistic propagation approach using matrix representations of probabilities associated with states of signals present at the various nodes and matrix representations of transfer of signals through the said components, and a determination of a reliability guideline resulting from the said global processing. This reliability guideline is, for example, determined at the level of at least one output node of the circuit.

According to a general characteristic of this aspect, in the presence in the circuit of at least one path termed a “reconvergence path” comprising a correlation source, several branches starting at the level of the correlation source and a component forming a sink where the branches culminate, the global processing comprises for each component of the path, a local processing comprising a computation of at least one conditional probability matrix containing the probabilities of the various states of a signal present at the level of this component, conditioned by the various states of at least one signal present at the level of this component or at the level of at least one node situated on the path upstream of the said component.

This makes it possible to determine the reliability guideline on the basis of signals which are independent or rendered independent, despite the presence of correlation sources. Indeed, conditioning a first signal present at the level of a component of a reconvergence path to a second signal present at the level of this same component or of a node connected upstream of this component on the reconvergence path makes it possible to render the first signal independent, that is to say to render independent the corresponding conditional probability matrix associated with it. It is then possible to circumvent the correlation effects and then carry out throughout the reconvergence path matrix operations of the SPR type whose results become exact.

As indicated above, it is possible to condition the various states of a signal to the various states of this same signal. In this case, the conditional probability matrix is the identity. This is, in particular, what is envisaged, for example, at the level of a primary or secondary correlation source.

It is also possible to condition the various states of a signal present at the level of a component to the various states of a signal present at the level of a previous component (situated upstream on the path) or else at the level of a correlation source.

It is also possible to condition a signal to several correlation sources. A signal present at the level of a node may be an input or output signal of the node. Finally, a node situated upstream of a component on a path signifies in particular that this node is situated on a path between the component and the correlation source or else is itself the correlation source.

According to one mode of implementation, the electronic circuit comprises at least one input node and the global processing comprises a computation, at the level of each input node, of an input matrix containing the probabilities of the various states of an input signal received at this node, as well as local processings of the matrix type associated with the components and involving local probability input matrices and probabilistic transfer and ideal transfer matrices for the components.

According to one mode of implementation, in the presence, at the level of a component forming a sink, of at least two signals mutually correlated by at least one correlation source, the local processing comprises, for each correlated signal, a computation, in the guise of local probability input matrix, of a conditional probability matrix containing the probabilities of the various states of the said correlated signal, conditioned by the various states of at least one signal delivered by at least one correlation source from which the correlated signal arises.

The correlated signals may be correlated by a single correlation source or several correlation sources, primary or secondary. And, the conditioned probability matrix associated with each correlated signal may be conditioned to one or more of these correlation sources. Moreover, the conditioning of the two probability matrices associated with the two correlated signals may be identical or different. And, according to one mode of implementation, the fact that the conditioning variables for the conditioned probability matrices are identical or different for the two matrices or else relate to a single or to several correlation sources, is of little significance. It suffices indeed simply to have for each conditioned matrix at the input of a sink, a conditioning to at least one correlation source, thereby rendering as explained above the two signals mutually independent and thus to be able to apply matrix operations of the SPR type at the level of the sink while being assured of obtaining an exact guideline at the output of the component.

The method advantageously comprises performing an analysis of the nodal network of the electronic circuit so as to determine the correlation source or sources, the reconvergence path or paths starting at the level of this or these correlation sources and the node or nodes or the sink at which this or these reconvergence paths culminate, each component of a sink receiving as input several correlated signals, that is to say at least two correlated signals.

According to a first variant, the local processing associated with a component forming a sink comprises for each of the correlated signals feeding this sink, a determination in the guise of local input matrix, of a conditioned matrix comprising the probabilities of the various states of the correlated signal, conditioned by the various states of the signal delivered by the correlation source feeding this sink if there is one, or else by the various states of the signals delivered by the correlation sources feeding this sink.

According to a second variant, which makes it possible especially to further reduce the calculation time and the necessary memory size, the local processing associated with a component forming a sink comprises, for each of the correlated signals feeding an input of this sink, a determination in the guise of local input matrix, of a conditioned matrix containing the probabilities of the various states of the said correlated signal, conditioned by the various states of the signal or signals delivered by the closest correlation source or sources connected to the said input of the sink.

According to a mode of implementation applicable in the first variant, when the correlated signals feeding the sink are correlated by a set of correlation sources, the determination of the conditioned local input matrix associated with each of the correlated signals feeding the said sink comprises, when a conditioned initial matrix associated with this correlated signal is conditioned to some of the correlation sources of the set, a modification of the conditioned initial matrix so as to render it conditioned to all the correlation sources of the set.

A modified matrix such as this then comprises, for example, a copy of each column of the conditioned initial matrix a number of times equal to the number of possible states of the signals delivered by the correlation sources not taken into account in the conditioned initial matrix. A kind of amplification of the size of the conditioned initial matrix is thus performed so as to obtain a matrix conditioned to all the correlation sources of the said set.

According to another mode of implementation applicable also to the first variant, when each correlated signal feeding the sink correlated by one and the same correlation source, the determination of the conditioned local input matrix associated with each of the correlated signals feeding the sink comprises, when a conditioned initial matrix associated with this correlated signal is not conditioned to the correlation source, a modification of the conditioned initial matrix so as to render it conditioned to the correlation source.

Thus, this modification advantageously comprises a matrix multiplication of the conditioned local output matrices of the components connected between the sink and the correlation source. In other words, a simple multiplication of conditioned matrices is performed here instead of performing an amplification of matrices by copying columns.

The nodal network of the electronic circuit can comprise at least one primary correlation source and at least one secondary correlation source. Each primary correlation source is a source from which at least one reconvergence path starts, and each secondary correlation source is a source from which at least one reconvergence path starts, this source moreover belonging to a reconvergence path fed by a previous correlation source, primary or secondary, placed upstream of the secondary correlation source.

According to one mode of implementation, applicable also in the first variant (less efficacious in terms of calculation time), the local processing of a component forming a secondary reconvergence source comprises a computation of two conditioned matrices, namely a conditioned local output matrix equal to the identity matrix and, a conditioned auxiliary matrix. The conditioned auxiliary matrix contains the probabilities of the various states of the local output signal delivered by this secondary source, conditioned by the various states of the signals delivered by the correlation sources situated upstream of this secondary source and linked to this secondary source.

The said conditioned local output matrix, that is to say the identity matrix, is then used as conditioned local input matrix for a component situated downstream of this secondary source on a reconvergence path and linked directly to this secondary source.

According to a mode of implementation applicable in the second variant, that is to say that making it possible to further reduce the calculation time, the local processing of a component forming a secondary reconvergence source also comprises a computation of two conditioned local output matrices, namely the identity matrix and a conditioned auxiliary matrix.

However, in this case, this conditioned auxiliary matrix contains the probabilities of the various states of the local output signal delivered by this secondary source, conditioned by the various states of the signals delivered by the correlation sources situated upstream of this secondary source and closest to this secondary source, and linked to this secondary source.

Here again, the conditioned local output matrix, that is to say the identity matrix, is used as a conditioned local matrix of a component situated downstream of this secondary source on a reconvergence path and linked directly to this secondary source.

Whatever variant is used, the local processing associated with a component situated on at least one reconvergence path and forming neither a correlation source nor a sink comprises, according to one mode of implementation, a computation of a local output matrix conditioned by the components situated immediately upstream of the component on each of the reconvergence paths, on the basis of conditioned matrices containing respectively the probabilities of the various states of the signals delivered by these upstream components conditioned by the various states of these same signals. These matrices are therefore the “identity” matrices.

The nodal network of the electronic circuit can comprise at least one internal sink and at least one final sink. A so-called internal sink is a sink at the level of which a reconvergence path terminates but which also forms an intermediate node of another reconvergence path. On the other hand, a final sink is a sink which does not belong to another reconvergence path.

According to one mode of implementation, the local processing associated with an internal sink comprises a computation, on the basis of the conditioned local input matrices associated with this internal sink, of a conditioned local output matrix containing the probabilities of the various states of the local output signal of the internal sink, conditioned by the various states of the signals conditioning the conditioned local input matrices of this internal sink.

The local processing associated with a final sink also comprises a computation of a conditioned local output matrix on the basis of the conditioned local input matrices associated with this final sink, but furthermore a processing for weighting the elements of this conditioned local output matrix, by the probabilities of the various states of the signals delivered by all the correlation sources linked to this final sink.

The difference between the local processing of an internal sink and that of a final sink therefore resides in the fact that no weighting processing is performed at the level of an internal sink so as to retain the conditioning as far as the final sink. Also, it is this weighting processing which makes it possible especially to take into account the various correlations of the signals in the determination of the reliability guideline. Also, some of the said probabilities used in the said weighting processing are advantageously elements of the conditioned auxiliary matrix or matrices which have been determined at the level of the secondary sources.

According to one mode of implementation, the weighting processing is applied to the columns of values of the conditioned output matrix of the final sink and the local processing of the final sink furthermore comprises on the basis of the result of this weighting processing, a computation of a local output matrix having the same size as each input matrix associated with an input node of the electronic circuit.

In other words, according to one mode of implementation, a matrix of the SPR type is computed, the reliability guideline being determined on the basis thereof if the final sink is an output node.

Thus, for example, in the case of an electronic circuit whose components comprise combinatorial elements, the computation of this reliability guideline comprises the sum of the probabilities of the output matrix of the output signal of the electronic circuit which are associated respectively with the states corresponding to correct values of the output signal.

In the course of the implementation of the method, it may be appropriate to compute a conditioned matrix associated with a component on the basis of a first matrix having a size equal to the input size of each input matrix associated with an input node of the electronic circuit, that is to say a matrix of the SPR type, and of an initial conditioned matrix. In this case, according to one mode of implementation, the computation of the conditioned matrix comprises a transformation of each column of the initial conditioned matrix into a first intermediate matrix having the input size, that is to say for example a matrix of the SPR type, and, for each first intermediate matrix, a matrix product involving the transpose of the ideal transfer matrix of the component. The probabilistic transfer matrix of this component, and the Kronecker product of the first matrix and the intermediate matrix, each matrix product providing a second intermediate matrix, and a transformation of each second intermediate matrix into a column vector, all the column vectors thus obtained from the conditioned matrix.

It may also be appropriate in the course of the method to compute a conditioned matrix associated with a component on the basis of a first initial conditioned matrix and of a second initial conditioned matrix; in this case, according to one mode of implementation, the computation of the conditioned matrix comprises a transformation of each column of the first initial conditioned matrix into a first intermediate matrix having the input size, that is to say a matrix of the SPR, and a transformation of each column of the second initial conditioned matrix into a second intermediate matrix having the input size, that is to say for example here again a matrix of the SPR type. For each first intermediate matrix and for each homologous second intermediate matrix, a matrix product involves the transpose of the ideal transfer matrix of the component, the probabilistic transfer matrix of this component and the Kronecker product of the first intermediate matrix and the second intermediate matrix, each matrix product providing a third intermediate matrix, a transformation of each third intermediate matrix into a column vector, the column vectors thus obtained forming the conditioned matrix.

Although not indispensable, it is preferable, for ease of computerized implementation, that the local processings are performed in a recursive manner from the outputs to the inputs of the electronic circuit, that is to say in the bottom up direction.

When, according to one mode of implementation, the components comprise combinatorial elements, each input signal of the electronic circuit and each output signal of the electronic circuit are logic signals able to take a first logic value (for example the value 0) or a second logic value (for example the value 1) and each input matrix associated with an input signal and the output matrix associated with the output signal is an elementary matrix of size 2×2. The output matrix comprises a probability that the first logic value is a correct value, corresponding to a first state of the signal, a probability that the first logic value is an incorrect value, corresponding to a second state of the signal, a probability that the first logic value is an incorrect value, corresponding to a third state of the signal, and a probability that the second logic value is a correct value, corresponding to a fourth state of the signal.

Also, preferably, each matrix of size 2×2 associated with the four possible states of a signal is arranged in such a way that the first column of the matrix contains the probability associated with the first state and the probability associated with the third state, and the second column of the matrix contains the probability associated with the second state and the probability associated with the fourth state. The diagonal of the matrix contains the probability associated with the first state and the probability associated with the fourth state. A conditioned matrix associated with a signal is arranged in such a way that a column of the conditioned matrix contains probabilities of the states of the signal respectively conditioned by one and the same state of a conditioning signal or of a set of conditioning signals, two different non-duplicated columns of the conditioned matrix being respectively associated with two different states of the conditioning signal or of the set of conditioning signals.

Such an arrangement of a conditioned matrix eases the implementation of the method by making it possible especially to perform simple matrix multiplications of conditioned matrices when this is necessary so as to transform the conditioning of an initial conditioned matrix.

According to another aspect, there is proposed a computerized system, for example a portable or non-portable computer or else a processor and its associated memories, comprising means or circuitry configured to implement the method as defined above.

According to another aspect, there is proposed a computer program product loadable directly into a memory of a computerized system, comprising software code portions for the execution of the method such as defined above when the said program is executed on the said computerized system.

According to another aspect, there is proposed a medium readable by a computerized system, having computer-executable instructions adapted for causing the execution by the computerized system of the method such as defined above.

### BRIEF DESCRIPTION OF THE DRAWINGS

Other advantages and characteristics of the invention will be apparent on examining the detailed description of wholly non-limiting modes of implementation and embodiments, and the appended drawings in which:

FIG. 1 illustrates schematically the main steps of a mode of implementing a method according to the invention,

FIG. 2 schematically illustrates an example of a nodal network of an electronic circuit, according to the invention,

FIG. 3 illustrates an example of an unconditioned matrix representation of a signal, according to the invention,

FIG. 4 schematically illustrates examples of ITM and PTM matrices of a logic gate and of a matrix operation of the SPR type, according to the invention,

FIG. 5 schematically illustrates the various steps of a Kronecker product of two matrices, according to the invention,

FIG. 6 illustrates an exemplary arrangement of a conditioned probability matrix, according to the invention,

FIGS. 7 to 15 schematically illustrate certain aspects of modes of implementation of the method according to the invention, and

FIGS. 16 to 18 represent three different examples of networks of an electronic circuit making it possible to illustrate implementations of the method according to the invention.

### DETAILED DESCRIPTION OF THE PREFERRED EMBODIMENTS

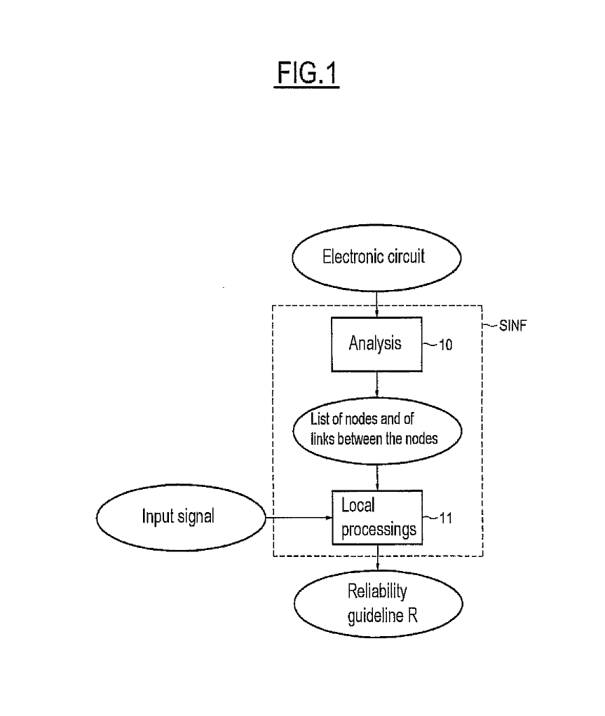

In FIG. 1, the reference SINF globally denotes a computerized system, for example a computer, comprising means or circuitry such as a central unit and memory means or circuitry, configured to implement a mode of implementation of the method according to the invention.

According to this mode of implementation illustrated in FIG. 1, provision is made first of all for an analysis 10 of the electronic circuit so as to establish a list of nodes and of links or connections between the nodes (“net list” according to a term well known to those skilled in the art). This list is for example stored in a memory of the computer and will be used to perform local processings 11 at the level of the components of the electronic circuit so as to provide on the basis of one or more input signals a guideline of reliability R at the level of an output signal of the electronic circuit.

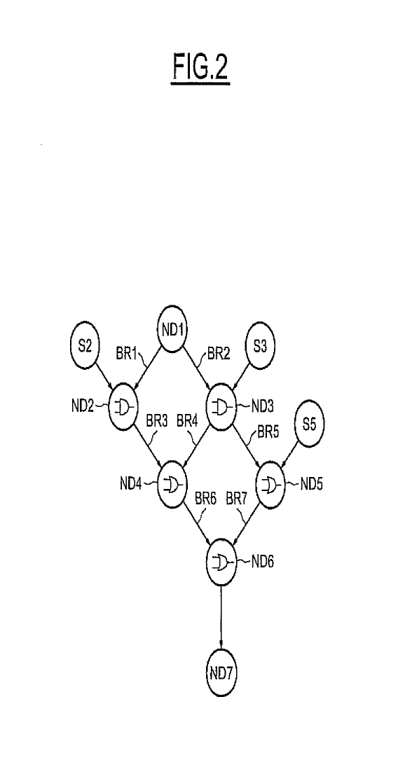

The list of nodes and of links between the nodes is for example written in a VHDL or Verilog language. An exemplary nodal network is illustrated in FIG. 2. It comprises four input nodes ND1, S2, S3, S5, an output node ND7 and intermediate nodes ND2, ND3, ND4, ND5, ND6, interconnected between the input nodes and the output nodes and at the level of which are situated components of the electronic circuit, here combinatorial elements comprising logic gates although the invention is not limited to this type of component.

The node ND7 has been represented as a different node from the node ND6 so as to clearly indicate the output node, but in practice the output node is also formed by a component. The analysis 10 of the electronic circuit will make it possible to identify the primary and secondary correlation sources, and also the reconvergence paths arising from these correlation sources, and the internal or final sinks.

More precisely, in the example of FIG. 2, the node ND1 forms a primary correlation source from which there departs a first reconvergence path comprising the branch BR1, BR3 on the one hand and the branch BR2 and BR4 on the other hand and culminating at a sink ND4.

From the source ND1 there also departs another reconvergence path comprising firstly the branch BR1, BR3, BR6, secondly the branch BR2, BR5, BR7 and thirdly the branch BR2, BR4, BR6. This other reconvergence path culminates at the sink ND6.

The node ND3 moreover forms a secondary correlation source from which there departs another reconvergence path comprising on the one hand the branch BR4, BR6, and on the other hand the branch BR5 and BR7 and which also culminates at the sink ND6. The sink ND4 is an internal sink since it belongs in particular to the reconvergence path terminating at the sink ND6. The sink ND6 is a final sink since it does not belong to an other reconvergence path.

The signals reaching the internal sink ND4 are mutually correlated signals and the correlation sources feeding this sink are the sources ND1 and ND3. On the other hand, the signals reaching the node ND2 are mutually independent just like the signals reaching the node ND3 and the node ND5. Finally, the signals reaching the node ND6 are also mutually correlated signals and the correlation sources feeding this final sink ND6 are the sources ND1 and ND3.

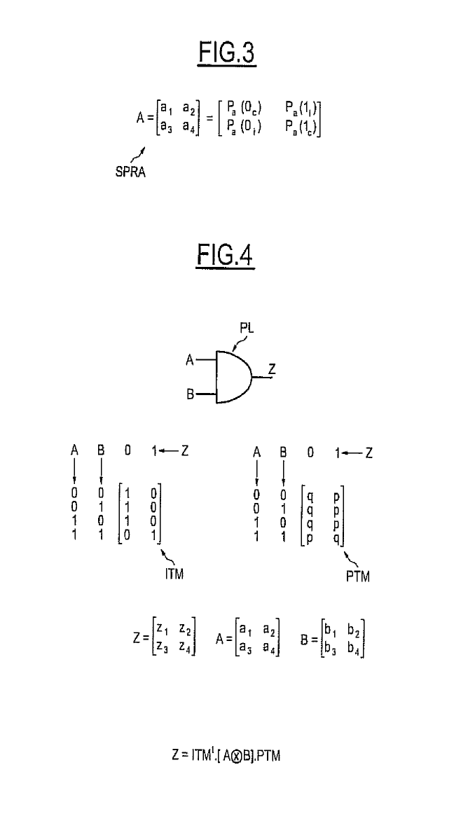

An input matrix associated with an input logic signal A is here a matrix of size 2×2. As illustrated in FIG. 3, the elements a₁-a₄ represent respectively the probability that this signal A exhibits a correct “0” state, the probability that this signal exhibits an incorrect “1” state, the probability that this signal exhibits an incorrect “0” state, and the probability that this signal exhibits a correct “1” state. Such a matrix will be dubbed hereinafter a matrix of the SPR type or SPR matrix, since this kind of matrix is commonly used in the SPR procedure according to the prior art.

FIG. 4 schematically illustrates the obtaining of an output matrix Z of the SPR type delivered by a logic gate PL, here an AND logic gate, receiving as input two signals A and B represented by their matrix of SPR type A and B. To perform this operation, an ITM ideal transfer matrix of the component and a PTM probabilistic transfer matrix of this same component are used.

As illustrated in this FIG. 4, the ITM matrix is derived from the truth table of the component PL and contains the probabilities of obtaining a state of the output signal as a function of the states of the input signals in the case where the component is assumed perfect, that is to say not generating any error.

On the other hand, the PTM matrix contains these same probabilities, but taking account of the probability p of intrinsic errors of the component. In the PTM matrix, q is equal to 1−p. As illustrated in FIG. 4, the computation of the matrix Z comprises a matrix product of three matrices, namely in order the matrix transpose of the ITM matrix, a matrix resulting from the Kronecker product (symbolized by [symbol] ), of the matrices A and B, and the PTM matrix.

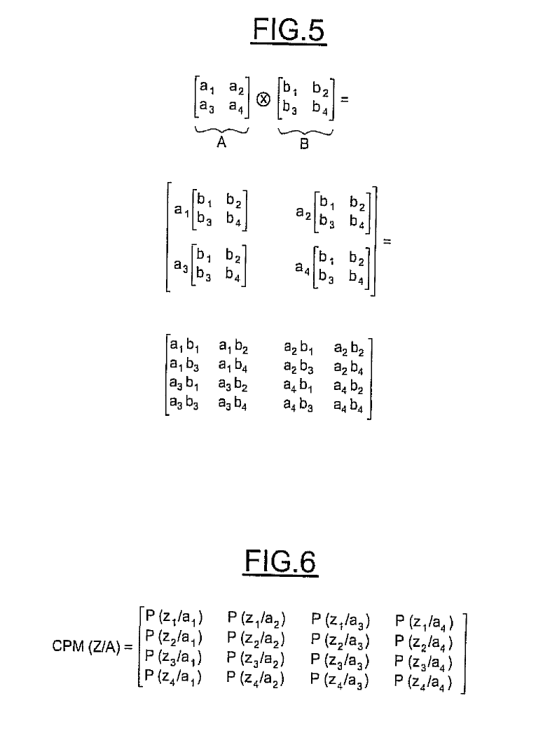

The Kronecker product of two matrices is well known to those skilled in the art. An implementation thereof in the case of two matrices A and B of SPR type is recalled here, with reference to FIG. 5. The matrix resulting from the Kronecker product of the matrices A and B illustrated at the top of FIG. 5, is illustrated at the bottom of FIG. 5.

Of course if the component exhibits a single input, like an inverter, there is in this case no desire to perform a Kronecker product. The output SPR matrix of the inverter is then simply obtained through the matrix product of the matrix transpose of the ITM matrix, of the SPR matrix of the input, and of the PTM matrix of the inverter.

As will be seen in greater detail hereinafter, provision is advantageously made to use, in estimating the reliability of the electronic circuit, a conditional probability matrix, termed the conditioned matrix or CPM matrix, which will make it possible to circumvent the effects of correlation of the signals correlated in the matrix operations of the SPR type such as those illustrated at the bottom of FIG. 4.

In FIG. 6 is illustrated the CPM matrix associated with the signal Z and conditioned by the signal A. More precisely, this matrix contains the conditional probabilities P (zᵢ/aⱼ) of the states zᵢ of the signal Z, conditioned by the states aⱼ of the signal A.

And, in the example illustrated, this CPM matrix is arranged in such a way that a column of the conditioned matrix contains the probabilities of all the states zᵢ, i=1 to 4, of the signal Z, conditioned by one and the same state aⱼ of the conditioning signal A.

More precisely, the first column of the CPM matrix relates to the states zᵢ conditioned to the state a1 while the second column relates to the states zᵢ conditioned to the state a2, while the third column relates to the states zᵢ conditioned to the state a3 and while the fourth column relates to the states zᵢ conditioned to the state a4.

This particular construction of CPM matrices will make it possible, as will be seen in greater detail hereinafter, to obtain very easily in certain cases CPM matrices by matrix multiplication of other CPM matrices.

Hereinafter in the text, a conditional probability matrix CPM (Z/A) containing the probabilities of the various states of the signal Z, conditioned by the various states of the signal A, will also be denoted by the term “conditioned matrix” or “CPM matrix of Z conditioned to A”. The local processing performed at the level of each component of the electronic circuit depends on the position and the function of the component in the nodal network.

Thus, this local processing will differ depending on whether the component situated at the level of a node forms a primary correlation source, a secondary correlation source, an internal sink, a final sink, or else a simple intermediate node situated on a reconvergence path.

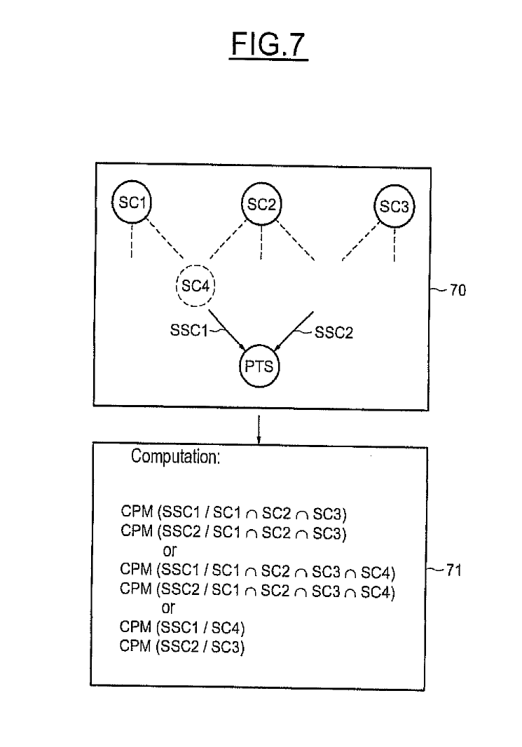

In FIG. 7 has been represented an exemplary local processing performed at the input of a sink PTS. More precisely, it is assumed here as illustrated in the box 70 of FIG. 7 that the nodal network comprises three primary correlation sources SC1, SC2 and SC3 and that the sink PTS receives as input two mutually correlated signals SSC1, SSC2 arising from these correlation sources.

In this case, the local processing can comprise, for each of the correlated signals SSC1 and SSC2, a computation 71 of a CPM matrix conditioning the correlated signal corresponding to all the correlation sources SC1, SC2, SC3 from which each correlated signal arises.

It should be noted here that the mathematical symbol (∩) representing an intersection here signifies “and.” It signifies in particular that in this case all the possible combinations of the states of the signals delivered by these correlation sources will be taken into account.

In the case where, as illustrated in the box 70 of FIG. 7, provision is furthermore made for a secondary correlation source SC4 linked for example to the primary correlation sources SC1, SC2 and SC3 and delivering the correlated signal SSC1, it is then possible to calculate as input CPM matrix of the node PTS, a CPM matrix of the signal SSC1 conditioned by the set of correlation sources SC1, SC2, SC3, SC4 feeding the sink PTS. The same holds for the CPM matrix of the correlated signal SSC2.

As a variant, in the case where the signal SSC1 arises directly from the secondary source SC4 and where the signal SSC2 arises directly from the source SC3, it would be possible to calculate for the signal SSC1, a CPM matrix conditioned solely to the secondary source SC4, and for the signal SSC2, a CPM matrix conditioned solely to the correlation source SC3.

In the latter case, not only are the CPM matrices of the signals SSC1 and SSC2 not conditioned to the set of correlation sources from which the signals SSC1 and SSC2 arise, but the conditioning variable is different for the two correlated signals since it involves the correlation source SC4 for the signal SSC1 and the correlation source SC3 for the correlated signal SSC2. As will be seen in greater detail hereinafter, such a variant implementation makes it possible to further reduce the time for calculating the reliability guideline and also to reduce the size of the CPM matrices used and consequently to reduce the memory size.

Be that as it may, whatever variant is implemented, by computing for each of the correlated signals SSC1 and SSC2 a matrix conditioned to at least one correlation source from which the correlated signal arises, these signals are rendered mutually independent, and this will make it possible to use these input CPM matrices for matrix calculations of the SPR type.

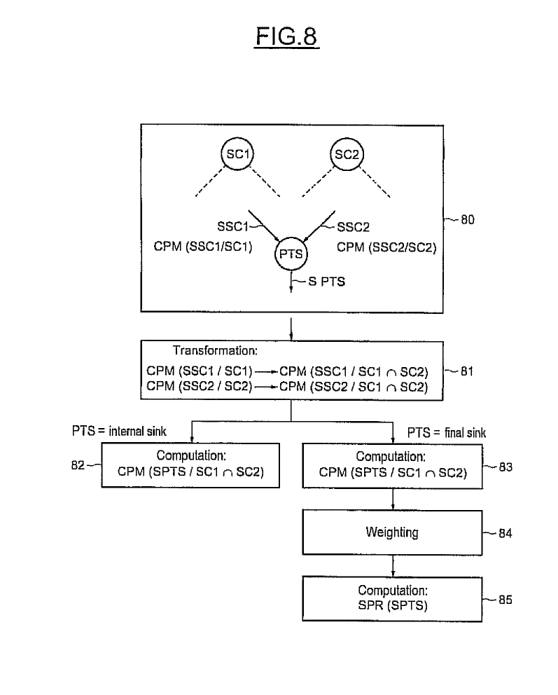

In the mode of implementation illustrated in FIG. 8, the case is considered where the CPM matrices of the correlated signals SSC1 and SSC2 may be conditioned to the set of correlation sources from which they arise, so as to allow the calculation of the CPM matrix associated with the output signal SPTS of the sink PTS.

The case is also considered where, as illustrated in the box 80 of FIG. 8, the initial CPM matrix of the signal SSC1 is conditioned to the correlation source SC1 while the initial CPM matrix of the signal SSC2 is conditioned only to the correlation source SC2.

In this case, the local processing of the sink PTS comprises a transformation 81 of the initial CPM matrix of the signal SSC1 so as to obtain a CPM matrix of the signal SSC1 conditioned to the set of correlation sources SC1 and SC2. Likewise, the CPM initial matrix of the signal SSC2 is transformed into a CPM matrix also conditioned to the set of correlation sources.

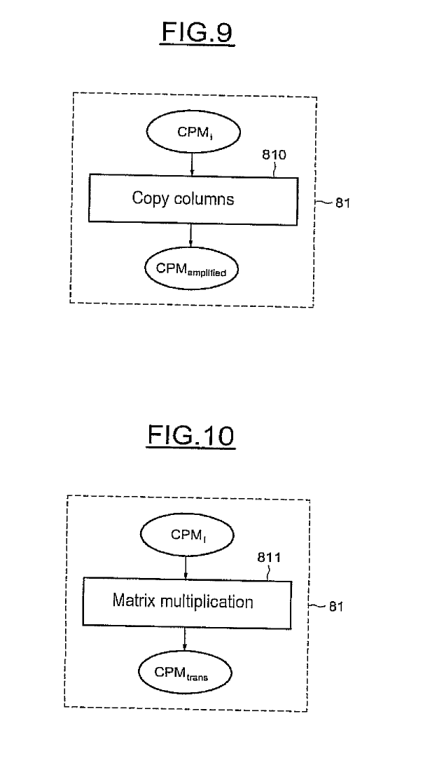

As illustrated in FIG. 9, such a transformation of an initial CPM matrix CPMi can comprise a copying 810 of each column of the initial matrix CPMi a number of times equal to the possible number of states of the signals delivered by the correlation sources not taken into account in the conditioned initial matrix.

A transformed matrix which is in fact an “amplified” matrix CPM_{amplified} is then obtained. This is the case when there are several correlation sources from which the correlated signals SSC1 and SSC2 arise.

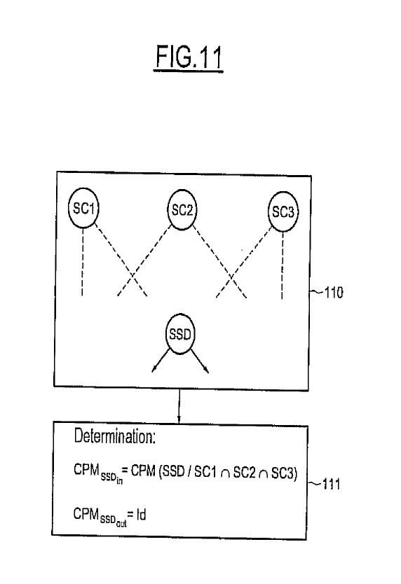

On the other hand, when these correlated signals are correlated by one correlation source, and one of the initial CPM matrices of a correlated signal is not conditioned to this correlation source, the transformation 81 can comprise, as illustrated in FIG. 10, a simple matrix multiplication 811 of the conditioned local output matrices of the components connected between the sink and the correlation source. A transformed CPM matrix CPMₜᵣₐₙₛ is then obtained.

Now returning to FIG. 8, it is seen that the local processing of the sink PTS continues, after transformation of the input CPM matrices, with a computation of an output CPM matrix. This output CPM matrix is in fact the CPM matrix of the output signal SPTS of the sink PTS, conditioned by the set of correlation sources SC1 and SC2.

This output CPM matrix is obtained on the basis of the transformed input CPM matrices. Such a computation 82 is performed in the case where the sink PTS is an internal sink. This computation 83 is also performed in the case where the sink PTS is a final sink.

However, in the case where the sink PTS is a final sink, the computation 83 continues through a weighting processing 84 of the elements of this output CPM matrix involving the probabilities of the various states of the signals delivered by the correlation sources linked to this final sink.

This weighting processing 84 is applied to the columns of values of the output CPM matrix and the local processing of the final sink furthermore comprises on the basis of the result of this weighting processing, a computation 85 of a local output matrix of the SPR type having a size here equal to 2×2.

This SPR matrix (SPTS) associated with the output signal SPTS of the final sink PTS, then forms the probability matrix for the states of the output signal of the electronic circuit if this final sink PTS forms the output node. In this case, the reliability guideline will be determined on the basis of this SPR matrix (SPTS).

In the case where the node PTS is not the output node of the electronic circuit, this SPR matrix (SPTS) may be combined in matrix fashion at the level of one other component of the electronic circuit with another matrix of the SPR type relating to another input signal of this other component.

Reference is now made to FIG. 11 to illustrate an exemplary local processing performed at the level of a secondary correlation source SSD. In the example described here, and illustrated in the box 110 of FIG. 11, this secondary correlation source SSD is linked to three primary correlation sources SC1, SC2 and SC3.

For a secondary correlation source, a conditioned local output matrix CPM_{SSDout} is computed which is equal to the identity matrix. Indeed, this conditioned local output matrix is the CPM matrix of the output signal of the secondary source conditioned by itself.

It is this identity matrix which will be used as CPM conditioned local input matrix of a component situated downstream of this secondary source on a reconvergence path and linked directly to this secondary source.

In addition to the computation of this conditioned local output matrix equal to the identity, for the secondary correlation source SSD, a conditioned auxiliary matrix CPM_{SSDin} is computed, which contains the probabilities of the various states of the local output signal SSD delivered by this secondary source, conditioned by the various states of the signals delivered by the correlation sources situated upstream of this secondary source and linked to this secondary source.

In the present case, the matrix CPM_{SSDin} is equal to the CPM matrix of the signal SSD, conditioned by the set of correlation sources SC1, SC2 and SC3.

It will be seen in greater detail hereinafter that this conditioned auxiliary matrix contains probabilities which will be used in the weighting processing performed at the level of the final sink fed by this secondary correlation source.

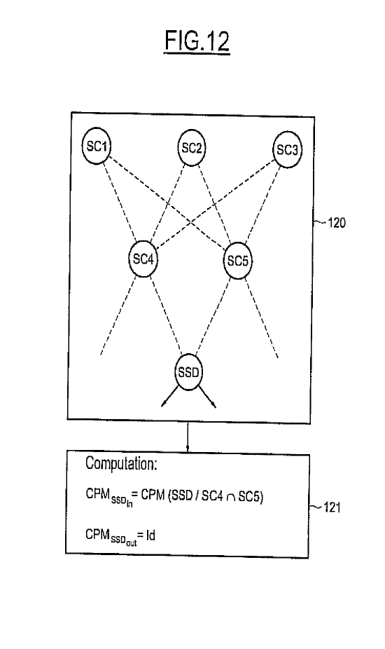

In FIG. 12, another exemplary local processing performed at the level of the secondary source SSD is illustrated. In this example, as illustrated in the box 120 of FIG. 12, the secondary source SSD is linked to three primary correlation sources SC1, SC2 and SC3 by way of two secondary correlation sources SC4 and SC5.

Thus, in this example, the correlation sources situated upstream of the secondary source SSD and closest to this correlation source SSD are the correlation sources SC4 and SC5.

Whereas in the examples of implementation illustrated in FIG. 11, the CPM matrix of the output signal SSD delivered by this secondary source, conditioned to the set of correlation sources SC1, SC2, SC3, SC4 and SC5, would have been calculated as matrix CPM_{SSDin}, here the CPM matrix of the signal SSD, conditioned only to the set of correlation sources closest to the secondary source SSD, namely the correlation sources SC4 and SC5, is computed (step 121) as conditioned auxiliary matrix CPM_{SSDin}.

This makes it possible as explained above and as detailed hereinafter in an example, to limit the size of the conditioned matrices and to further reduce the calculation time. Moreover, as in the exemplary implementation of FIG. 11, the identity matrix is also computed as conditioned local output matrix CPM_{SSDout} of this secondary source SDD. Here again, it is this identity matrix which will be used in the guise of input CPM matrix for a component situated immediately downstream of the secondary source SSD on a reconvergence path.

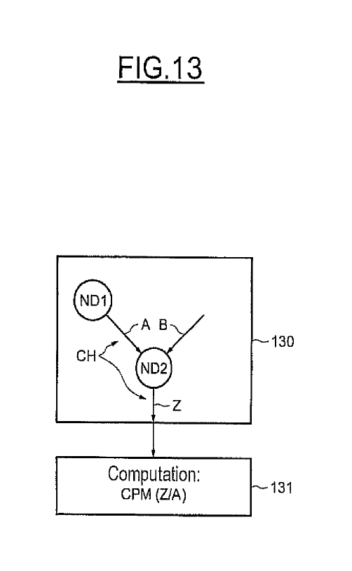

In FIG. 13 is schematically illustrated an exemplary local processing performed at the level of a component ND2 which is neither a secondary correlation source, nor an internal sink, nor a final sink but simply a component possessing an input and an output belonging to a reconvergence path CH.

It is assumed in this example that the input signal of the component ND2 received by way of the reconvergence path CH is the signal A. The signal B is for its part a signal independent of the signal A and the signal Z is the output signal delivered by the component ND2.

In this case, a CPM matrix of the signal Z, conditioned by the signal A delivered by the component situated immediately upstream of the node ND2 on the reconvergence path, is simply computed (step 131). This CPM (Z/A) matrix is calculated on the basis of the SPR matrix of the signal B which does not belong to the reconvergence path, and on the basis of a CPM matrix, which is not the CPM matrix of the output signal delivered by the node ND1, but which is the identity matrix. Indeed, the node ND1 will be used as conditioning variable, and the input CPM matrix of the node ND2 will therefore contain the probabilities P(ND1ᵢ/ND1ⱼ) of the states of the signal ND1, conditioned by the states of the signal ND1.

In a local processing, it may be appropriate to perform matrix operations of the SPR type on two input SPR matrices so as to obtain an output SPR matrix. This has already been mentioned with reference to FIG. 4.

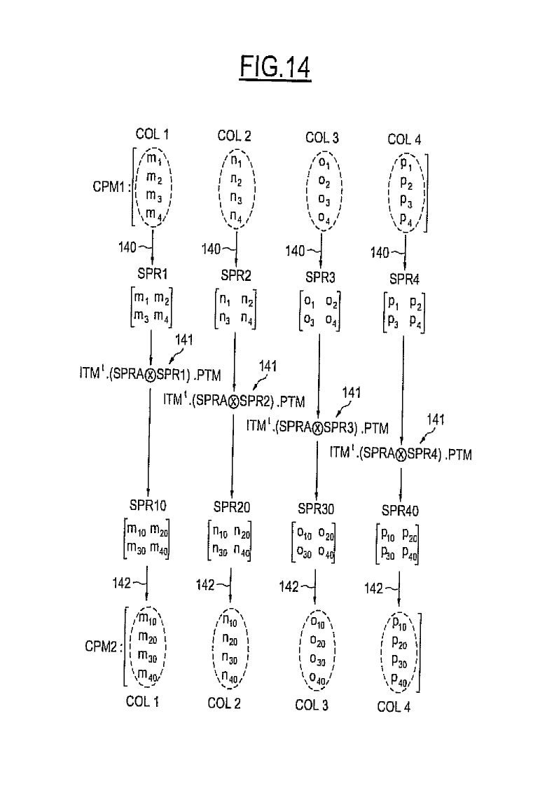

It may also be appropriate, in a local processing, to compute a conditioned matrix CPM2 associated with a component on the basis of a first matrix of the SPR type and of an initial conditioned matrix. An exemplary computation of a conditioned matrix such as this CPM2 is illustrated in FIG. 14.

More precisely, here it is desired to compute the matrix CPM2 on the basis of the matrix SPRA of the SPR type and of the conditioned matrix CPM1. The first step (140) is aimed at transforming each column COL1-COL4 of the matrix CPM1 into an intermediate matrix SPR1-SPR4 of the SPR type.

Next, for each intermediate matrix SPRi, a matrix product of the SPR type of this intermediate matrix SPRi and the matrix SPRA is performed (step 141) by involving the transpose of the ITM matrix of the component together with the PTM matrix of this component.

Second intermediate matrices SPR10, SPR20, SPR30 and SPR40 are then obtained. A transformation 142 of each second intermediate matrix into a column vector is performed thereafter, the column vectors thus obtained forming the columns COL1-COL4 of the conditioned matrix CPM2.

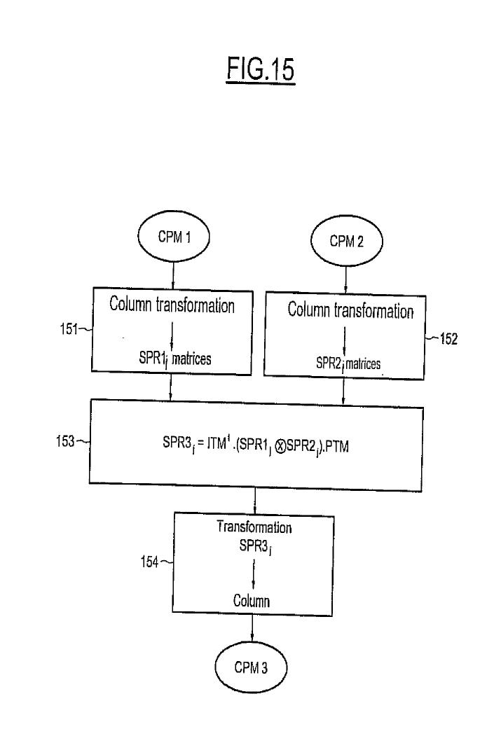

It is also possible, in the course of a local processing associated with a component, to compute, as illustrated in FIG. 15, a conditioned matrix CPM3 on the basis of a first initial conditioned matrix CPM1 and of a second initial conditioned matrix CPM2.

In this case, such a computation comprises a transformation 151 of each column of the first matrix CPM1 into a first intermediate matrix of the SPR type and a transformation 152 of each column of the second matrix CPM2 into a second intermediate matrix of the SPR type.

Next, for each first intermediate matrix SPR1ⱼ and for each homologous second intermediate matrix SPR2ⱼ, a matrix product 153 of the SPR type is performed so as to obtain a third intermediate matrix SPR3ⱼ.

Each third intermediate matrix SPR3ⱼ is then transformed into a column vector (step 154). The column vectors thus obtained then form the said conditioned matrix CPM3.

Reference is now made more particularly to annexe 1 hereinafter, which forms an integral part of the present description and which describes, in a language of the pseudocode type, an exemplary implementation of a mode of implementation of the method of estimating reliability of the electronic circuit within a computerized system.

This program, although implemented in the C++ language, is described here in pseudocode for the sake of simplification. In the pseudocode language used, the term “node” denotes a node of the electronic circuit, and the term “edge” denotes a connection between two nodes.

In the mode of implementation described here, the algorithm has been implemented in a recursive form, starting from the outputs of the electronic circuit. The program comprises a software module denoted “Apply_CPM” which is called for the output nodes and for all the input nodes (Annexe 1(1)).

The pseudocode of the “Apply_CPM” module is described in point (2) of annexe 1. In this regard, the “analyze-path” software module calculates the conditional probability matrix of the connection (“edge”) calling the module and the probabilities thus obtained are conditioned by the sources feeding the path in which the said connection is situated.

The “compute_CPM_matrix” module determines a CPM matrix while the “compute_out_CPM” module determines the two CPM matrices associated with a secondary source. The “compute_edges_SPR_matrix” software module determines an SPR matrix associated with a connection.

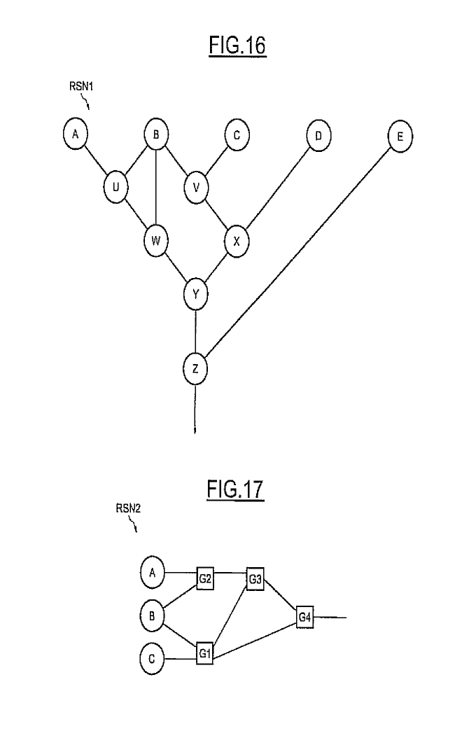

Reference is now made more particularly to FIG. 16 and to annexe 2, which also forms an integral part of the present description, to describe, in a particular example, a mode of implementation of the method according to the invention.

In FIG. 16, the nodal network RSN1 comprises input nodes A, B, C, D, E. Moreover, “AND” gates with two inputs are respectively placed at the level of nodes U, V and Y while “OR” gates with two inputs are respectively placed at the level of nodes W, X and Z. Node Z also forms the output of the electronic circuit.

For the sake of simplification, the output signal of a node will also be named by the name of this node. For example, the output signal of node A will be called A.

It is considered here that the SPR matrix representing the distribution of the inputs at the level of a node may be identical for the inputs. It is also considered that these inputs are not noisy, that is to say they contain correct values, and are equiprobable for the “1” and “0” logic states. Consequently, the SPR matrix associated with each of the input nodes is defined in point (1) of annex 2.

It is also considered that all the logic gates have the same probability of error, in this instance a probability P equal to 0.05. Consequently, the ITM and PTM matrices associated with an “AND” gate are defined in points (2) and (3) of annex 2 while the ITM and PTM matrices associated with an “OR” gate are defined in points (4) and (5) of annex 2.

Analysis of the graph of the network RSN1 shows that node B is a correlation source. Three reconvergence paths depart from this correlation source.

A first path comprises the branches B-U-W and B-W. This reconvergence path culminates at the sink W. Another reconvergence path comprises the branches B-W-Y and B-V-X-Y and culminates at the sink Y. Finally, the third reconvergence path comprises the branches B-U-W-Y and B-V-X-Y and culminates at the sink Y. The sink W is consequently an internal sink and the sink Y a final sink.

Whereas it was previously seen that it was possible to perform an analysis of the graph and the corresponding local processings in the ascending direction, that is to say from the outputs towards the inputs, here an analysis and a processing will be performed in the descending direction, that is to say from the inputs towards the outputs.

### Processing of Node U

This node U is fed by a branch or connection which originates from node A and by a branch which originates from node B. This node U is therefore situated in a reconvergence path. The CPM matrix of node U will therefore be calculated as defined in point (6) of annexe 2.

To calculate this matrix CPM_{U}, the SPR matrix of the signal A is used directly since node A is not situated in any reconvergence path. This SPR matrix of node A is defined in point (7) of annexe 2.

Regarding node B which is situated in a reconvergence path and which in this instance is itself the correlation source, the CPM matrix of this node B which contains the probability of the various states of B conditioned by the various states of B will be used, that is to say the identity matrix. This matrix CPM_{B} is indicated in point (8) of annexe 2.

The calculation of the matrix CPM_{U} will consequently be performed on the basis of the SPR matrix of node A and of the CPM matrix of node B in an analogous manner to what was described with reference to FIG. 14. It should be noted here that the calculation of the CPM matrix of node U is performed by the “compute_CPM_matrix” software module mentioned in annexe 1.

In a first step, the first column of the matrix CPM_{B} is taken and it is cast into the form of an SPR matrix (annexe 2, point (9)). It should be noted that this obtaining of the SPR matrix on the basis of the column of the CPM matrix is obtained by the “compute_edges_SPR_matrix” module of the pseudocode of annexe 1.

Next, the matrix SPR₁ is calculated on the basis of the matrix SPR_{A} and of the matrix SPR_{B1}, in accordance with point (10) of annexe 2. The result is given in point (11) of annexe 2.

This SPR matrix is thereafter transformed into a column vector (point (12) of annexe 2) which will form the first column of the matrix CPM_{U}. These same operations are repeated for the second column of the matrix CPM_{B} (points (13) and (14) of annexe 2) so as to obtain (point (15) of annexe 2) the second column of the matrix CPM_{U}.

The same operations are repeated for the third and fourth columns of the matrix CPM_{B} (points (15) to (19) of annexe 2) so as ultimately to obtain the matrix CPM_{U} represented in point (20) of annexe 2.

### Processing of Node W

This node is an internal sink which receives two mutually correlated signals. The two CPM matrices as input for this node W are the matrices CPM_{U} and CPM_{B}.

The CPM matrix of this sink W will be calculated on the basis of the matrices CPM_{U} and CPM_{B} in a manner analogous to that which was described with reference to FIG. 15. More precisely, the first column of the matrix CPM_{U} is transformed into an SPR matrix (annexe 2, point (21)). The same operation is performed for the first column of the matrix CPM_{B} so as to obtain an SPR matrix (annexe 2, point (22)). Next, an intermediate SPR matrix is calculated (annexe 2, point (23)) which is transformed into a column vector (annexe 2, point (24)) that will form the first column of the matrix CPM_{W}.

The same operations are performed for the other three columns of the matrices CPM_{U} and CPM_{B} (annexe 2, points (25)-(36)) so as ultimately to obtain the CPM matrix of node W, illustrated in point (37) of annexe 2. It should be noted here that, since the sink W is an internal sink and not a final sink, no weighting processing is performed on the matrix CPM_{W} since it is necessary to retain the conditioning guideline up to the final sink Y.

### Processing of Node V

The characteristics of this node are similar or identical to those of node U. Indeed, one of these inputs may not belong to a reconvergence path while the other belongs to this reconvergence path and is linked directly to the reconvergence source. Moreover, the type of gate of node V is the same as the type of gate of node U. Consequently, the CPM matrix of this node V is equal to the CPM matrix of node U (annexe 2, point (38)).

### Processing of Node X

This time an “OR” gate is involved. One of the inputs of node X belongs to a reconvergence path, in this instance that originating from node V, while the other input, that originating from node D, does not belong to the reconvergence path.

Node V will therefore be a conditioning variable for the calculation of the CPM matrix of the input of node X, which is linked to node V. This CPM matrix will therefore contain the probabilities P(vᵢ/vⱼ). It therefore involves the identity matrix.

The way of calculating the output CPM matrix of node X, which is defined in point (39) of annexe 2, on the basis of the input CPM matrix originating from node V (the “identity” matrix) and of the SPR matrix of node D, is similar or identical to that which was described for the calculation of the CPM matrix of node U on the basis of the SPR matrix of node A and of the CPM matrix of node B.

These operations, which are mentioned in points (40) to (52) of annexe 2 and which make it possible to culminate in the obtaining of the CPM_{X} matrix mentioned in point (53) of annexe 2, will therefore not be returned to in greater detail.

### Processing of Node Y

This node is a final sink, that is to say the signals arising from the correlation source B are found there. For this final sink Y, it is firstly appropriate to calculate its output CPM matrix on the basis of the two input CPM matrices.

However, in this mode of implementation, it is appropriate that the two input CPM matrices be conditioned in the same manner to the correlation source B. Now, the matrix CPM_{W}, arising from an internal sink, is already conditioned by the correlation source B. There is therefore no transformation operation to be performed on this matrix.

On the other hand, the CPM_{X} matrix is conditioned by the variable V. However, the output CPM matrix of node V is moreover available, which matrix is conditioned by the correlation source B. Consequently, the values of probabilities of the various states xᵢ of the signal X, conditioned by the various states bⱼ of the signal B, may be obtained easily on the basis of formula (54) of annexe 2.

Consequently, on account of the above-described construction of the CPM matrices, the product of the CPM matrix of node X and the CPM matrix of node V will provide a transformed CPM matrix associated with node X and referenced CPM_{X′} (annexe 2, point (55)).

As shown in point (56) of annexe 2, this transformed matrix does indeed contain the sought-after probabilities, and consequently a conditioning to the correlation source B. The values of this transformed matrix are illustrated in point (57) of annexe 2.

The columns of the CPM matrix of node Y will thereafter be calculated, in a manner analogous to what was described previously, on the basis of the two input CPM matrices. The operations relating to this calculation are detailed in points (58) to (73) of annexe 2 and the four columns of this output CPM matrix of node Y are explained in points (61), (65), (69) and (73) of annexe 2.

A weighting processing will thereafter be performed on these columns with the probabilities of the various states of the signals delivered by all the correlation sources linked to this final sink, in this instance by the probabilities of the various states of the signal delivered by the sole correlation source B.

The weight to be applied to each column of the output CPM matrix of node Y is given by the corresponding elements of the SPR matrix of the correlation source B which is recalled in point (74) of annexe 2. In other words, the weight of columns 1 and 4 of the output CPM matrix of node Y is equal to 0.5 and the weight of columns 2 and 3 is equal to 0.

The elements of each column of the output CPM matrix of node Y are consequently multiplied by the corresponding weight, and a row-by-row summation of these columns thus weighted is performed so as to obtain a resulting column that is thereafter transformed into an SPR matrix forming the output SPR matrix of node Y.

Of course, instead of weighting each column, of summing them and of transforming the resulting column into an SPR matrix, it is possible to transform each column into an SPR matrix, weight this SPR matrix with the corresponding weight, and sum all the weighted SPR matrices to obtain the output SPR matrix. This output SPR matrix is explained in point (75) of annexe 2.

### Processing of Node Z

This is the last node to be processed. This node may not belong to a reconvergence path. Therefore the matrix operations of the SPR type can be applied in a direct manner since its two inputs receive mutually independent signals.

To calculate the output SPR matrix of this node Z, the two SPR matrices of the two branches converging on this node Z, that is to say the SPR matrix of node Y (point (75) of annexe 2) and the SPR matrix of node E (point (76) of annexe 2) are therefore taken as inputs.

The output SPR matrix of node Z is determined as indicated previously by formula (77) of annexe 2, thereby making it possible to obtain the matrix mentioned in point (78) of this annexe 2. The reliability guideline R for the circuit is obtained on the basis of this matrix SPR_{Z} by summing the elements of this matrix which are associated with states representing correct values of signals, that is to say a correct “0” and a correct “1”. The elements z₁ and z₄ will therefore be summed so as to obtain as mentioned in point (79) of annexe 2, a reliability, that is to say in fact a probability value, of about 89%.

Reference is now made more particularly to FIG. 17 and to annexe 3 which also forms an integral part of the present description, to describe another exemplary implementation of the method. In this example, the nodal network RSN2 comprises three input nodes A, B, C, four components situated at the level of nodes G1, G2, G3 and G4, node G4 also forming the output node of the circuit.

“AND” gates with two inputs are placed at the level of nodes G1 and G2 while “OR” gates with two inputs are placed at the level of nodes G3 and G4. Here again, it is considered that the inputs are not noisy and are equiprobable for the “1” and “0” logic states. In other words, the SPR matrix of each input is defined by point (1) of annexe 3.

In a manner analogous to what was described with reference to annexe 2, the ITM and PTM matrices of the “AND” and “OR” gates are defined in points (2) to (5) of annexe 3. In this network RSN2, there is a primary correlation source, namely node B, and a secondary correlation source, namely node G1, an internal sink G3 and a final sink G4.

The reconvergence paths are as follows. For the correlation source B, a path comprises the two branches B-G2-G3 and B-G1-G3, and a path comprising the three branches B-G2-G3-G4, B-G1-G3-G4 and B-G1-G4.

Moreover, there also exists a reconvergence path arising from the secondary correlation source G1, namely the path comprising the branches G1-G3-G4 and G1-G4.

### Processing of Node G2

The local processing of node G2 is analogous to the local processing of node U of the network RSN1 of FIG. 16. Consequently, this local processing will not be returned to again in detail here.

The output CPM matrix of this node G2 is defined in point (6) of annexe 3 and the numerical values of this matrix are mentioned in point (7) of annexe 3.

### Processing of Node G1

This node is a secondary correlation source. As indicated previously, for a secondary source two CPM matrices are determined, namely, a CPM matrix containing the probabilities of the states of the output signal delivered by this secondary source, conditioned by the various states of the signal delivered by the correlation source B linked to this secondary source.

This matrix CPM_{G1in} is determined in the same manner as the CPM matrix of node G2. It is depicted in point (8) of annexe 3.

It should be noted here that this matrix is in fact an auxiliary CPM matrix which is not used as input CPM matrix for a node situated downstream of this secondary source, for example node G3. On the other hand, its terms will be used in the weighting processing performed at the level of the final sink.

The second CPM matrix computed at the level of this secondary source is a matrix containing the probabilities of the various states of the signal G1 delivered by this secondary source, conditioned by the various states of this same signal. It is therefore the identity matrix, which is referenced here by the reference CPM_{G1out} depicted in point (9) of annexe 3.

It is this output matrix, in this instance the identity matrix, which will be used in the guise of input CPM matrix for the local processing of node G3 and for the local processing of node G4.

### Processing of Node G3

This node is an internal sink. The correlation sources which sustain this sink are the sources B and G1, therefore a CPM matrix containing the probabilities of the states of the signal G3, conditioned by all the possible combinations of the states of the signals B and G1 (point (10) of annexe 3), is computed as output from this node G3. To obtain such a CPM matrix as output, it is necessary that the CPM matrices as input to this sink be also conditioned by the two sources B and G1.

Now, one of the inputs is the CPM matrix of node G2, which is conditioned by the source B, and the other input of node G3 is the CPM matrix of node G1, conditioned by this same node, that is to say the identity matrix. It is therefore helpful to modify these two matrices in such a way that they are conditioned by the two correlation sources B and G1.

Since the CPM matrix of node G2 is conditioned by B, it is consequently independent of G1. Therefore, rendering the CPM matrix of node G2 conditioned by B and G1 amounts to copying the values of the CPM matrix of node G2 into a new larger matrix which will contain the desired conditioning. In practice, each column of the matrix CPM_{G2} will be copied here four times into a larger matrix to obtain the probability values defined in point (11) of annexe 3.

This larger matrix, dubbed CPM_{G2amplified}, is consequently depicted in point (12) of annexe 3. This matrix thus amplified therefore contains four groups of columns and each group contains four identical columns. For the sake of simplification only the first column and the last column of each group are depicted in point (12) of annexe 3.

The other CPM matrix, that is to say the matrix CPM_{G1out}, which is equal to the identity matrix, has been rendered independent of B on account of its conditioning by node G1. Here again, it is appropriate to amplify this matrix so as to render it conditioned to the two correlation sources B and G1.

The same operation is therefore performed of copying columns in the same order of conditioning and the matrix CPM_{Gloutamplified} depicted in point (13) of annexe 3 is ultimately obtained. Once these two matrices have been amplified, a local processing analogous to that which was described with reference to FIG. 15 is applied to them to obtain the output CPM matrix of node G3. The first eight columns of the CPM matrix of node G3 are depicted in point (14) of annexe 3 and the last eight columns are represented in point (15) of annexe 3.

### Processing of Node G4

This node is a final sink. The local processing to be performed is therefore analogous to that carried out for the internal sink with the particular feature that this time it is helpful furthermore to apply a weighting processing by using the probabilities of the possible combinations of the states of the signals delivered by the two correlation sources B and G1.

And, since G1 depends on B, it may not be possible to perform a simple multiplication of the probabilities of the states of B by the probabilities of the states of G but it is helpful to use the formula mentioned in point (16) of annexe 3.

And, it is remarked here that the first term of the product mentioned in point (16) of annexe 3 is in fact contained in the auxiliary CPM matrix associated with the secondary source G1 and referenced CPM_{G1in}.

Before performing the calculation of the output CPM matrix of the sink G4 and performing the weighting processing on the columns of this matrix, it is helpful that the two input CPM matrices of node G4 be conditioned by the same convergence sources. Whereas the matrix CPM_{G3} is already conditioned by B and G1, that originating from node G1, that is to say the identity, is conditioned by G1.

It is therefore appropriate to apply the same amplification operations to this matrix as those which were described previously for the processing of node G3 so as to obtain a matrix CPM_{G1amplified}.

Next, the same operations are carried out as those which were described for node Y of the network RSN1. More precisely, each weighted SPR matrix associated with each column ik of the output CPM matrix of node G4 is obtained through formula (17) of annexe 3.

The summation of these SPR matrices makes it possible to obtain the final SPR matrix of node G4, described in point (18) of annexe 3. The reliability of the circuit is therefore obtained as described previously, through formula (19) of annexe 3. A reliability of the order of 85% is therefore obtained here.

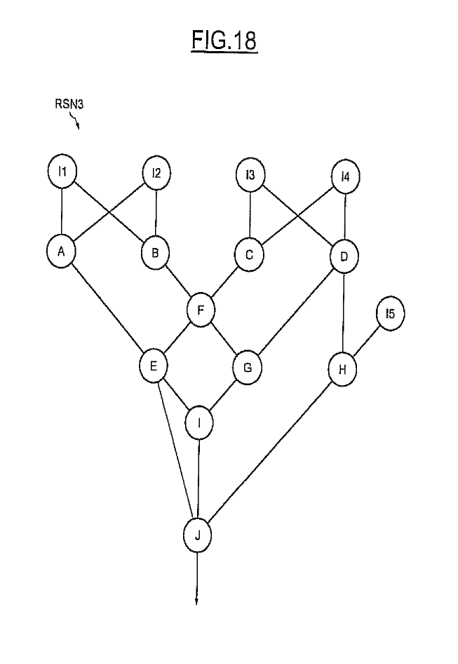

Reference is now made more particularly to FIG. 18 and to annexe 4 which also forms an integral part of the description to describe another exemplary implementation of the method according to the invention in a variant making it possible to further reduce the calculation time with respect to the implementations which have just been described with reference to FIGS. 16 and 17.

The network RSN3 of FIG. 18 comprises nodes I1, I2, I3, I4 and I5 as input nodes. The network moreover comprises logic gates of the “AND” type with two or three inputs at nodes A to J.

Node J represents the output node of the circuit. By analogy with the previous examples, non-noisy and equiprobable input SPR matrices will again be chosen and here again it will be assumed that the gates have an intrinsic error probability equal to 0.05.

The network RSN3 is a more complex network which exhibits nested reconvergence paths. In this network, the primary correlation sources are situated at the level of nodes I1, I2, I3 and I4. The secondary sources are nodes E, F, D.

The internal sinks are nodes E, G and I, and the final sink is node J. The branches of the reconvergence paths of this circuit are as follows. For the source I1 and the sink E, the branches are I1-A-E, and I1-B-F-E. For the source I1 and the sink I, the branches are I1-A-E-I, I1-B-F-E-I, and I1-B-F-G-I. For the source I1 and the sink J, the branches are I1-A-E-I-J, I1-B-F-E-I-J, I1-B-F-G-I-J, I1-A-E-J, and I1-B-F-E-J.

For the source I2 and the sink E, the branches are I2-A-E, and I2-B-F-E. For the source I2 and the sink I, the branches are I2-A-E-I, I2-B-F-E-I, and I2-B-F-G-I. For the source I2 and the sink J, the branches are I2-A-E-I-J, I2-B-F-E-I-J, I2-B-F-G-I-J, I2-A-E-J, and I2-B-F-E-J. For the source I3 and the sink G, the branches are I3-D-G, and I3-C-F-G. For the source I3 and the sink I, the branches are I3-D-G-I, I3-C-F-E-I, and I3-C-F-G-I.

For the source I3 and the sink J, the branches are I3-D-G-I-J, 13-C-F-E-I-J, I3-C-F-G-I-J, I3-D-H-J, and I3-C-F-E-J. For the source I4 and the sink I, the branches are I4-D-G-I, I4-C-F-E-I, and I4-C-F-G-I. For the source I4 and the sink J, the branches are I4-D-G-I-J, I4-C-F-E-I-J, I4-C-F-G-I-J, I4-D-H-J, and I4-C-F-E-J. For the source F and the sink I, the branches are F-E-I, and F-G-I. For the source F and the sink J, the branches are F-E-J, F-E-I-J, and F-G-I-J. For the source D and the sink J, the branches are D-G-I-J, and D-H-J. For the source E and the sink J, the branches are E-I-J, and E-J.

In the previous modes of implementation which have just been described, when processing a sink, final or not, or when processing a secondary source, an amplification of the input CPM matrices is carried out so as on the one hand to condition each of the input CPM matrices to the same correlation sources, and on the other hand to condition them to all the correlation sources feeding the sink, whether they are primary or secondary:

This matrix amplification operation gives rise, as has been seen, to a copying of the same guidelines a certain number of times, thereby leading in particular to increasing the size of the matrices. The exemplary implementation which will now be described with reference to FIG. 18 makes it possible to avoid this operation of duplicating columns. That said, so that the two modes of implementation can culminate in the same result, the conditioning guideline which resulted from this duplication of columns should not be lost.

This is the reason why, in this implementation termed “optimized”, since it makes it possible in particular to decrease the calculation time, this guideline will be recovered at the level of the weighting processing which will be a more unwieldy processing than the weighting processing of the non-optimized implementation. However, the weighting processing essentially results in multiplications of scalars, which is much less constraining than matrix operations.

As a consequence of eliminating this matrix amplification operation, it is no longer necessary, in a local processing of a sink, or in a local processing of a secondary source, to condition the input CPM matrices of these nodes, on the one hand in an identical manner, and on the other hand to all the correlation sources which feed this node. Indeed, it then suffices to condition these input CPM matrices to the correlation sources closest to this node.

Hereinafter in the text, the calculations of the various CPM matrices will not be detailed since these calculations have already been explained in the previous modes of implementation. Emphasis will simply be placed in particular on the size of these matrices and the differences in conditioning with respect to the previous variant.

### Processing of Node A

The output CPM matrix of node A will be conditioned to the correlation sources I1 and I2, and consequently, the matrix CPM_{A} will contain the probabilities P(aᵢ|I1ⱼ∩I2ₖ).

The matrices CPM (I1/I1) and CPM (I2/I2), which are the “identity” matrices, will be used in this regard. The size of this matrix CPM_{A} is 4×16 (16 is the number of possible combinations between the four possible states of I1 and the four possible states of I2)

### Processing of Node B

The processing of node B is similar to that of node A. The matrix CPM_{B} will contain the probabilities P(bᵢ|I1ⱼ∩I2ₖ).

### Processing of Node C

The processing of node C is similar to those of nodes A and B but in this case, the conditioning variables are the correlation sources I3 and I4. Therefore, the matrix CPM_{C} will contain the probabilities: P(cᵢ|I3ⱼ∩I4ₖ).

### Processing of Node F

This node is a secondary correlation source. As already explained, two CPM matrices will therefore be calculated for this secondary source. A first matrix will contain the conditioning by the correlation sources prior to this secondary source, in this instance the correlation sources I1, I2, I3 and I4. Consequently, this matrix CPM_{Fin} will contain the probabilities P(fᵢ|I1ⱼ∩I2ₖ∩I3ₗ∩I4ₘ). The size of this matrix is equal to 4×256.

The second matrix calculated is the matrix CPM_{Fout} which is the matrix of the signal F conditioned by itself, therefore the identity matrix.

### Processing of Node E

This node E is both an internal sink and a secondary correlation source. Since it is a secondary correlation source, two CPM matrices are calculated, as for node F, namely an output matrix CPM_{Eout} which is the identity matrix, and an auxiliary CPM matrix CPM_{Ein}. The calculation of this auxiliary CPM matrix is performed on the basis of the two input CPM matrices of node E.

These two input CPM matrices are the CPM matrix of node A which is conditioned to the correlation sources I1 and I2 and the CPM matrix equal to the identity originating from the secondary source F. In the previous implementation, it would have been helpful to amplify these input CPM matrices so as to condition each of them to all the correlation sources linked to node E, that is to say to the correlation sources I1 I2, I3, I4 and F. Matrices having 4⁵ columns would therefore have been obtained.

In this implementation, each of the input CPM matrices of the correlation source E is simply conditioned to the closest correlation sources situated upstream of this source E and which feed it, that is to say the sources I1, I2 and F. Consequently, the CPM matrix of node A, which is conditioned to the sources I1 and I2, and also the identity matrix, which is conditioned to the source F, will be used as they are.

Thus, the auxiliary CPM matrix associated with this node E, referenced CPM_{Ein} will contain the probabilities P(eᵢ|I1ⱼ∩I2ₖ∩fₗ). The number of columns of this matrix is consequently equal to 4³.

It should also be noted here that since node E is both an internal sink and a secondary source, the output CPM matrix of the internal sink, which is normally calculated when the node is an internal sink, in fact corresponds here to the auxiliary CPM matrix calculated for the secondary source.

### Processing of Node D

This is also a secondary correlation source. The processings are therefore analogous to those performed for the other secondary sources. A matrix CPM_{Din} which will contain the probabilities P(dᵢ|I3ⱼ∩I4ₖ) and the matrix CPM_{Dout} which will contain P(dᵢ|dⱼ), that is to say the identity matrix, are therefore calculated.

### Processing of Node G

This node is an internal sink. The CPM matrices of the inputs are conditioned by F and by D respectively. Therefore, the matrix CFM_{G} will contain the probabilities P(gᵢ|fⱼ∩dₖ). A matrix of size 4×16 is therefore obtained.

If an implementation relating to the non-optimized variant had been used, then, for this sink G, it would have been necessary to condition each of the input CPM matrices to the correlation sources I1, I2, I3, I4, D and F, which would have led to a matrix amplification of the input CPM matrices.

Moreover, the output CPM matrix of node G would have also contained a conditioning by all the correlation sources and a matrix having 4⁶ columns would have been obtained. It should be noted here that even when an input CPM matrix is conditioned only to a single correlation source, in this instance the source D or the source F, these two matrices are representative of independent signals, and are so even if the conditioning is different between the input CPM matrices.

### Processing of Node H

This node has an input belonging to a reconvergence path and an input, that linked to node 15, which does not belong to this reconvergence path, therefore the CPM matrix to be calculated, CPM_{H}, will contain P(hᵢ|dⱼ).

It will be calculated on the basis of the CPM matrix of D conditioned by D (the identity matrix) and of the SPR matrix of I5.

### Processing of Node I

This node is an internal sink. The local processing is analogous to that performed for node G.

The CPM matrices of the inputs are conditioned by E, and by F and D, respectively. Therefore, the matrix CPM, will contain the probabilities P(iᵢ|eⱼ∩fₖ∩dₗ).

A matrix having 64 columns will therefore be obtained, whereas with the non-optimized implementation, which would have used an amplification of the CPM matrices of the inputs so as to condition them by the correlation sources, a conditioning by the set of correlation sources I1, I2, I3, I4, D, F and E would have been obtained, that is to say a matrix having 4⁷ columns.

### Processing of Node J

This node is a final sink. It is therefore helpful to apply a weighting processing in the local processing of this node, so as to obtain the final SPR matrix of this node, which here will be the output matrix of the electronic circuit.

For this node J, there are three inputs and consequently three CPM matrices, namely:

E: CPM_{Eout} which contains P(eᵢ|eⱼ).

I: CPM_{I} which contains P(iᵢ|eⱼ∩fₖ∩dₗ).

H: CPM_{H} which contains P(hᵢ|dₗ)

Just as for the processing of the internal sinks G and I, these three input matrices will be used without amplification thereof, to carry out the calculation of the final SPR matrix.

And, to calculate the weights to be applied during the weighting processing, the conditionings calculated in the CPM matrices relating to the secondary sources will be used.

An exemplary algorithm making it possible to perform these operations is written in pseudocode in annexe 4. The first three loops of this algorithm make it possible to assign a state to the three correlation sources E, F and D which are the conditioning variables intervening in the final sink.

Subsequent thereto, a calculation of the SPR type is carried out. In this regard, the column which corresponds to the combination of the inputs eⱼ, fₖ and dₗ is taken in each input CPM matrix of the final sink.

Thereafter, the weight of this operation is calculated. This weight may contain all the possible combinations of the primary inputs (at the level of the primary-correlation sources) which give this combination eⱼ, fₖ and dₗ at the level of the inputs of the secondary sources E, F and D.

This corresponds to the loop of the pseudocode beginning with weight=0. To calculate this weight, the auxiliary CPM matrix CPMᵢₙ calculated for each secondary source is used, so as to obtain conditioned probabilities respectively defined by the first three terms of the product appearing in the instruction for calculating the weight (beginning with weight-weight+) in the annexed pseudocode.

Finally, this matrix SPR_aux just calculated, weighted by the calculated weight, is accumulated in a matrix SPR_final and a processing for accumulating this matrix for the possible combinations of the primary and secondary correlation sources reaching the final sink is performed within a loop. The probabilities contained in the SPR matrices of the input nodes are therefore also used.

And, of course, once this final SPR matrix has been obtained, the reliability guideline is deduced therefrom in a manner analogous to that which was described previously.

With this implementation avoiding matrix amplification operations, the calculation time and the memory size used by the system during its execution are much lower. Indeed, the number of matrix operations to be carried out may be reduced to the strict minimum. In compensation, it is helpful to do many more scalar operations to calculate the weights of the matrix operations, but these scalar products are less constraining in terms of calculation time and memory size than matrix operations.

By way of indication, for the network illustrated in FIG. 18, the calculation time necessary for the implementation of the method according to the invention in the so-called “optimized” variant not using any matrix amplification, is of the order of 0.12 seconds whereas it would be of the order of 7.8 seconds if the so-called “Multipass SPR” procedure of the prior art were used.

By way of indication, if the method according to the invention were used in its non-optimized variant, that is to say with matrix amplifications, a calculation time of about 3.4 seconds would be obtained.

It is therefore remarked that the method according to the invention, in its so-called “optimized” variant, is about 70 times faster than the Multipass SPR procedure for the circuit of FIG. 18. And of course, the more reconvergence paths there are, the more the ratio of the calculation time of a Multipass SPR procedure to the calculation time of the method according to the invention will increase.

Annexe 1
(1)

```
for all - output nodes do
  for all - input - edges do
    apply_CPM
  end for
end for
```

Annexe 2
(2)

```
if node_source_is_sink then
  activate_path
  for all_input_edges do
    if edge_is_active then
      apply - CPM
      analyze _ PATH
    else
      apply _CPM
      compute_edges_SPR_matrix
    end if
  end for
  if node_is_final_sink then
    compute_edges_SPR_matrix
  else
    compute_out_CPM
  end if
else if node_source_is_reconvergence_source
then
  for all_input_edges do
    apply_CPM
    if edge_is_active then
      analyze - PATH
    else
      compute_edges_SPR_matrix
    end if
  end for
  if node == primary_source then
    compute_edges_SPR_matrix
  else
    compute_out_CPM
  end if
```

Annexe 1
(2) continuation and end

```
else
  for all_input_edges do
    apply - CPM
  end for
  if no_path_is_active then
    compute_edges_SPR_matrix
  else
    compute_CPM_matrix
  end if
end if
```

$$\begin{matrix}Annexe 2 & \\ {SPR}_{input} = ( \begin{matrix}{a}_{1} & {a}_{2} \\ {a}_{3} & {a}_{4}\end{matrix} ) = ( \begin{matrix}P ( {0}_{c} ) & P ( {1}_{i} ) \\ P ( {0}_{i} ) & P ( {1}_{c} )\end{matrix} ) = ( \begin{matrix}0.5 & 0 \\ 0 & 0.5\end{matrix} ) & ( 1 ) \\ {ITM}_{AND} = ( \begin{matrix}1 & 0 \\ 1 & 0 \\ 1 & 0 \\ 0 & 1\end{matrix} ) & ( 2 ) \\ {PTM}_{AND} = ( \begin{matrix}0.95 & 0.05 \\ 0.95 & 0.05 \\ 0.95 & 0.05 \\ 0.05 & 0.95\end{matrix} ) & ( 3 ) \\ {ITM}_{OR} = ( \begin{matrix}1 & 0 \\ 0 & 1 \\ 0 & 1 \\ 0 & 1\end{matrix} ) & ( 4 ) \\ {PTM}_{OR} = ( \begin{matrix}0.95 & 0.05 \\ 0.05 & 0.95 \\ 0.05 & 0.95 \\ 0.05 & 0.95\end{matrix} ) & ( 5 ) \\ {CPM}_{U} = ( \begin{matrix}P ( {u}_{1} / {b}_{1} ) & P ( {u}_{1} / {b}_{2} ) & P ( {u}_{1} / {b}_{3} ) & P ( {u}_{1} / {b}_{4} ) \\ P ( {u}_{2} / {b}_{1} ) & P ( {u}_{2} / {b}_{2} ) & P ( {u}_{2} / {b}_{3} ) & P ( {u}_{2} / {b}_{4} ) \\ P ( {u}_{3} / {b}_{1} ) & P ( {u}_{3} / {b}_{2} ) & P ( {u}_{3} / {b}_{3} ) & P ( {u}_{3} / {b}_{4} ) \\ P ( {u}_{4} / {b}_{1} ) & P ( {u}_{4} / {b}_{2} ) & P ( {u}_{4} / {b}_{3} ) & P ( {u}_{4} / {b}_{4} )\end{matrix} ) & ( 6 ) \\ {SPR}_{A} = ( \begin{matrix}{a}_{1} & {a}_{2} \\ {a}_{3} & {a}_{4}\end{matrix} ) = ( \begin{matrix}0.5 & 0 \\ 0 & 0.5\end{matrix} ) & ( 7 ) \\ {CPM}_{B} = ( \begin{matrix}1 & 0 & 0 & 0 \\ 0 & 1 & 0 & 0 \\ 0 & 0 & 1 & 0 \\ 0 & 0 & 0 & 1\end{matrix} ) & ( 8 ) \\ {SPR}_{B 1} = ( \begin{matrix}1 & 0 \\ 0 & 0\end{matrix} ) & ( 9 ) \\ {SPR}_{1} = {ITM}_{AND}^{T} \cdot ( {SPR}_{A} ⊗ {SPR}_{B 1} ) \cdot {PTM}_{AND} & ( 10 ) \\ {SPR}_{1} = ( \begin{matrix}0.95 & 0.05 \\ 0 & 0\end{matrix} ) & ( 11 ) \\ ( \begin{matrix}0.95 \\ 0.05 \\ 0 \\ 0\end{matrix} ) & ( 12 ) \\ {SPR}_{B 2} = ( \begin{matrix}0 & 1 \\ 0 & 0\end{matrix} ) & ( 13 ) \\ {SPR}_{2} = {ITM}_{AND}^{T} \cdot ( {SPR}_{A} ⊗ {SPR}_{B 2} ) \cdot {PTM}_{AND} & ( 14 ) \\ ( \begin{matrix}0.5 \\ 0.5 \\ 0 \\ 0\end{matrix} ) & ( 15 ) \\ {SPR}_{B 3} = ( \begin{matrix}0 & 0 \\ 1 & 0\end{matrix} ) & ( 16 ) \\ ( \begin{matrix}0.475 \\ 0.025 \\ 0.475 \\ 0.025\end{matrix} ) & ( 17 )\end{matrix}$$

$$\begin{matrix}S P {R}_{B 4} = ( \begin{matrix}0 & 0 \\ 0 & 1\end{matrix} ) & ( 18 ) \\ ( \begin{matrix}0.475 \\ 0.025 \\ 0.025 \\ 0.475\end{matrix} ) & ( 19 ) \\ C P {M}_{U} = ( \begin{matrix}0.95 & 0.5 & 0.475 & 0.475 \\ 0.05 & 0.5 & 0.025 & 0.025 \\ 0 & 0 & 0.475 & 0.025 \\ 0 & 0 & 0.025 & 0.475\end{matrix} ) & ( 20 ) \\ S P {R}_{U 1} = ( \begin{matrix}0.95 & 0.05 \\ 0 & 0\end{matrix} ) & ( 21 ) \\ S P {R}_{B 1} = ( \begin{matrix}1 & 0 \\ 0 & 0\end{matrix} ) & ( 22 ) \\ S P {R}_{1} = I T {M}_{OR}^{T} \cdot ( S P {R}_{U 1} ⊗ S P {R}_{B 1} ) \cdot P T {M}_{OR} & ( 23 ) \\ ( \begin{matrix}0.905 \\ 0.095 \\ 0 \\ 0\end{matrix} ) & ( 24 ) \\ S P {R}_{U 2} = ( \begin{matrix}0.5 & 0.5 \\ 0 & 0\end{matrix} ) & ( 25 ) \\ S P {R}_{B 2} = ( \begin{matrix}0 & 1 \\ 0 & 0\end{matrix} ) & ( 26 ) \\ S P {R}_{2} = I T {M}_{OR}^{T} \cdot ( S P {R}_{U 2} ⊗ S P {R}_{B 2} ) \cdot P T {M}_{OR} & ( 27 ) \\ ( \begin{matrix}0.05 \\ 0.95 \\ 0 \\ 0\end{matrix} ) & ( 28 ) \\ S P {R}_{U 3} = ( \begin{matrix}0.475 & 0.025 \\ 0.475 & 0.025\end{matrix} ) & ( 29 ) \\ S P {R}_{B 3} = ( \begin{matrix}0 & 0 \\ 1 & 0\end{matrix} ) & ( 30 ) \\ S P {R}_{3} = I T {M}_{OR}^{T} \cdot ( S P {R}_{V 3} ⊗ S P {R}_{B 3} ) \cdot P T {M}_{OR} & ( 31 ) \\ ( \begin{matrix}0 \\ 0 \\ 0.905 \\ 0.095\end{matrix} ) & ( 32 ) \\ S P {R}_{U 4} = ( \begin{matrix}0.475 & 0.025 \\ 0.025 & 0.475\end{matrix} ) & ( 33 ) \\ S P {R}_{B 4} = ( \begin{matrix}0 & 0 \\ 0 & 1\end{matrix} ) & ( 34 ) \\ S P {R}_{4} = I T {M}_{OR}^{T} \cdot ( S P {R}_{U 4} ⊗ S P {R}_{B 4} ) \cdot P T {M}_{OR} & ( 35 ) \\ ( \begin{matrix}0 \\ 0 \\ 0.05 \\ 0.95\end{matrix} ) & ( 36 ) \\ C P {M}_{W} = ( \begin{matrix}0.905 & 0.05 & 0 & 0 \\ 0.095 & 0.95 & 0 & 0 \\ 0 & 0 & 0.905 & 0.05 \\ 0 & 0 & 0.095 & 0.95\end{matrix} ) & ( 37 ) \\ C P {M}_{V} = ( \begin{matrix}0.95 & 0.5 & 0.475 & 0.475 \\ 0.05 & 0.5 & 0.025 & 0.025 \\ 0 & 0 & 0.475 & 0.025 \\ 0 & 0 & 0.025 & 0.475\end{matrix} ) & ( 38 ) \\ C P {M}_{X} = ( \begin{matrix}P ( {x}_{1} / {v}_{1} ) & P ( {x}_{1} / {v}_{2} ) & P ( {x}_{1} / {v}_{3} ) & P ( {x}_{1} / {v}_{4} ) \\ P ( {x}_{2} / {v}_{1} ) & P ( {x}_{2} / {v}_{2} ) & P ( {x}_{2} / {v}_{3} ) & P ( {x}_{2} / {v}_{4} ) \\ P ( {x}_{3} / {v}_{1} ) & P ( {x}_{3} / {v}_{2} ) & P ( {x}_{3} / {v}_{3} ) & P ( {x}_{3} / {v}_{4} ) \\ P ( {x}_{4} / {v}_{1} ) & P ( {x}_{4} / {v}_{2} ) & P ( {x}_{4} / {v}_{3} ) & P ( {x}_{4} / {v}_{4} )\end{matrix} ) & ( 39 ) \\ S P {R}_{D} = ( \begin{matrix}0.5 & 0 \\ 0 & 0.5\end{matrix} ) & ( 40 )\end{matrix}$$

$$\begin{matrix}S P {R}_{V 1} = ( \begin{matrix}1 & 0 \\ 0 & 0\end{matrix} ) & ( 41 ) \\ S P {R}_{1} = I T {M}_{OR}^{T} \cdot ( S P {R}_{V 1} ⊗ S P {R}_{D} ) \cdot P T {M}_{OR} & ( 42 ) \\ ( \begin{matrix}0.475 \\ 0.025 \\ 0.025 \\ 0.475\end{matrix} ) & ( 43 ) \\ S P {R}_{V 2} = ( \begin{matrix}0 & 1 \\ 0 & 0\end{matrix} ) & ( 44 ) \\ S P {R}_{2} = I T {M}_{OR}^{T} \cdot ( S P {R}_{V 2} ⊗ S P {R}_{D} ) \cdot P T {M}_{OR} & ( 45 ) \\ ( \begin{matrix}0.025 \\ 0.475 \\ 0.025 \\ 0.475\end{matrix} ) & ( 46 ) \\ S P {R}_{V 3} = ( \begin{matrix}0 & 0 \\ 1 & 0\end{matrix} ) & ( 47 ) \\ S P {R}_{3} = I T {M}_{OR}^{T} \cdot ( S P {R}_{V 3} ⊗ S P {R}_{D} ) \cdot P T {M}_{OR} & ( 48 ) \\ ( \begin{matrix}0 \\ 0 \\ 0.5 \\ 0.5\end{matrix} ) & ( 49 ) \\ S P {R}_{V 4} = ( \begin{matrix}0 & 0 \\ 0 & 1\end{matrix} ) & ( 50 ) \\ S P {R}_{4} = I T {M}_{OR}^{T} \cdot ( S P {R}_{V 4} ⊗ S P {R}_{D} ) \cdot P T {M}_{OR} & ( 51 ) \\ ( \begin{matrix}0 \\ 0 \\ 0.05 \\ 0.95\end{matrix} ) & ( 52 ) \\ C P {M}_{X} = ( \begin{matrix}0.475 & 0.025 & 0 & 0 \\ 0.025 & 0.475 & 0 & 0 \\ 0.025 & 0.025 & 0.5 & 0.05 \\ 0.475 & 0.475 & 0.5 & 0.95\end{matrix} ) & ( 53 ) \\ P ( {x}_{i} / {b}_{j} ) = P ( {x}_{i} / {v}_{k} ) \cdot P ( {v}_{k} / {b}_{j} ) & ( 54 ) \\ C P {M}_{X}^{′} = C P {M}_{X} \cdot C P {M}_{V} & ( 55 ) \\ C P {M}_{X}^{′} = ( \begin{matrix}P ( {x}_{1} / {b}_{1} ) & P ( {x}_{1} / {b}_{2} ) & P ( {x}_{1} / {b}_{3} ) & P ( {x}_{1} / {b}_{4} ) \\ P ( {x}_{2} / {b}_{1} ) & P ( {x}_{2} / {b}_{2} ) & P ( {x}_{2} / {b}_{3} ) & P ( {x}_{2} / {b}_{4} ) \\ P ( {x}_{3} / {b}_{1} ) & P ( {x}_{3} / {b}_{2} ) & P ( {x}_{3} / {b}_{3} ) & P ( {x}_{3} / {b}_{4} ) \\ P ( {x}_{4} / {b}_{1} ) & P ( {x}_{4} / {b}_{2} ) & P ( {x}_{4} / {b}_{3} ) & P ( {x}_{4} / {b}_{4} )\end{matrix} ) & ( 56 ) \\ C P {M}_{X}^{′} = ( \begin{matrix}0.4525 & 0.2500 & 0.2265 & 0.2262 \\ 0.0475 & 0.2500 & 0.0238 & 0.0238 \\ 0.0250 & 0.0250 & 0.2512 & 0.0488 \\ 0.4750 & 0.4750 & 0.4987 & 0.7012\end{matrix} ) & ( 57 ) \\ S P {R}_{W 1} = ( \begin{matrix}0.905 & 0.05 \\ 0 & 0\end{matrix} ) & ( 58 ) \\ S P {R}_{X 1}^{′} = ( \begin{matrix}0.4525 & 0.0475 \\ 0.025 & 0.475\end{matrix} ) & ( 59 ) \\ S P {R}_{1} = I T {M}_{AND}^{T} \cdot ( S P {R}_{W 1} ⊗ S P {R}_{X 1}^{′} ) \cdot P T {M}_{AND} & ( 60 ) \\ ( \begin{matrix}0.9053 \\ 0.0947 \\ 0 \\ 0\end{matrix} ) & ( 61 ) \\ S P {R}_{W 2} = ( \begin{matrix}0.05 & 0.95 \\ 0 & 0\end{matrix} ) & ( 62 ) \\ S P {R}_{X 2}^{′} = ( \begin{matrix}0.25 & 0.25 \\ 0.025 & 0.475\end{matrix} ) & ( 63 ) \\ S P {R}_{2} = I T {M}_{AND}^{T} \cdot ( S P {R}_{W 2} ⊗ S P {R}_{X 2}^{′} ) \cdot P T {M}_{AND} & ( 64 ) \\ ( \begin{matrix}0.3301 \\ 0.6699 \\ 0 \\ 0\end{matrix} ) & ( 65 )\end{matrix}$$

$$\begin{matrix}S P {R}_{W 3} = ( \begin{matrix}0 & 0 \\ 0.905 & 0.095\end{matrix} ) & ( 66 ) \\ S P {R}_{X 3}^{′} = ( \begin{matrix}0.2262 & 0.0238 \\ 0.2512 & 0.4987\end{matrix} ) & ( 67 ) \\ S P {R}_{3} = I T {M}_{AND}^{T} \cdot ( S P {R}_{W 3} ⊗ S P {R}_{X 3}^{′} \cdot P T {M}_{AND} & ( 68 ) \\ ( \begin{matrix}0.2355 \\ 0.0145 \\ 0.6698 \\ 0.0801\end{matrix} ) & ( 69 ) \\ S P {R}_{W 4} = ( \begin{matrix}0 & 0 \\ 0.05 & 0.95\end{matrix} ) & ( 70 ) \\ S P {R}_{X 4}^{′} = ( \begin{matrix}0.2262 & 0.0238 \\ 0.0488 & 0.7012\end{matrix} ) & ( 71 ) \\ S P {R}_{4} = I T {M}_{AND}^{T} \cdot ( S P {R}_{W 4} ⊗ S P {R}_{X 4}^{′} ) \cdot P T {M}_{AND} & ( 72 ) \\ ( \begin{matrix}0.2172 \\ 0.0328 \\ 0.1130 \\ 0.6370\end{matrix} ) & ( 73 ) \\ S P {R}_{B} = ( \begin{matrix}0.5 & 0 \\ 0 & 0.5\end{matrix} ) & ( 74 ) \\ S P {R}_{Y} = ( \begin{matrix}0.5612 & 0.0638 \\ 0.0565 & 0.3185\end{matrix} ) & ( 75 ) \\ S P {R}_{E} = ( \begin{matrix}0.5 & 0 \\ 0 & 0.5\end{matrix} ) & ( 76 ) \\ S P {R}_{Z} = I T {M}_{OR}^{T} \cdot ( S P {R}_{Y} ⊗ S P {R}_{E} ) \cdot P T {M}_{OR} & ( 77 ) \\ S P {R}_{Z} = ( \begin{matrix}0.2682 & 0.0443 \\ 0.0598 & 0.6277\end{matrix} ) & ( 78 ) \\ reliability = {z}_{1} + {z}_{4} = 0.2682 + 0.6277 = 0.8959 & ( 79 )\end{matrix}$$

$$\begin{matrix}Annexe 3 & \\ {SPR}_{input} = ( \begin{matrix}{a}_{1} & {a}_{2} \\ {a}_{3} & {a}_{4}\end{matrix} ) = ( \begin{matrix}P ( {0}_{c} ) & P ( {1}_{i} ) \\ P ( {0}_{i} ) & P ( {1}_{c} )\end{matrix} ) = ( \begin{matrix}0.5 & 0 \\ 0 & 0.5\end{matrix} ) & ( 1 ) \\ {ITM}_{AND} = ( \begin{matrix}1 & 0 \\ 1 & 0 \\ 1 & 0 \\ 0 & 1\end{matrix} ) & ( 2 ) \\ {PTM}_{AND} = ( \begin{matrix}0.95 & 0.05 \\ 0.95 & 0.05 \\ 0.95 & 0.05 \\ 0.05 & 0.95\end{matrix} ) & ( 3 ) \\ {ITM}_{OR} = ( \begin{matrix}1 & 0 \\ 0 & 1 \\ 0 & 1 \\ 0 & 1\end{matrix} ) & ( 4 ) \\ {PTM}_{OR} = ( \begin{matrix}0.95 & 0.05 \\ 0.05 & 0.95 \\ 0.05 & 0.95 \\ 0.05 & 0.95\end{matrix} ) & ( 5 ) \\ {CPM}_{G 2} = ( \begin{matrix}P ( g {2}_{1} / {b}_{1} ) & P ( g {2}_{1} / {b}_{2} ) & P ( g {2}_{1} / {b}_{3} ) & P ( g {2}_{1} / {b}_{4} ) \\ P ( g {2}_{2} / {b}_{1} ) & P ( g {2}_{2} / {b}_{2} ) & P ( g {2}_{2} / {b}_{3} ) & P ( g {2}_{2} / {b}_{4} ) \\ P ( g {2}_{3} / {b}_{1} ) & P ( g {2}_{3} / {b}_{2} ) & P ( g {2}_{3} / {b}_{3} ) & P ( g {2}_{3} / {b}_{4} ) \\ P ( g {2}_{4} / {b}_{1} ) & P ( g {2}_{4} / {b}_{2} ) & P ( g {2}_{4} / {b}_{3} ) & P ( g {2}_{4} / {b}_{4} )\end{matrix} ) & ( 6 ) \\ {CPM}_{G 2} = ( \begin{matrix}0.95 & 0.5 & 0.475 & 0.475 \\ 0.05 & 0.5 & 0.025 & 0.025 \\ 0 & 0 & 0.475 & 0.025 \\ 0 & 0 & 0.025 & 0.475\end{matrix} ) & ( 7 ) \\ {CPM}_{G 1 in} = ( \begin{matrix}0.95 & 0.5 & 0.475 & 0.475 \\ 0.05 & 0.5 & 0.025 & 0.025 \\ 0 & 0 & 0.475 & 0.025 \\ 0 & 0 & 0.025 & 0.475\end{matrix} ) & ( 8 ) \\ {CPM}_{G 1 out} = ( \begin{matrix}1 & 0 & 0 & 0 \\ 0 & 1 & 0 & 0 \\ 0 & 0 & 1 & 0 \\ 0 & 0 & 0 & 1\end{matrix} ) & ( 9 ) \\ P ( g {3}_{i} \vert {b}_{j} ⋂ g {1}_{k} ) & ( 10 ) \\ P ( g {2}_{i} \vert {b}_{j} ⋂ g {1}_{1} ) , P ( g {2}_{i} \vert {b}_{j} ⋂ g {1}_{2} ) , \\ P ( g {2}_{i} \vert {b}_{j} ⋂ g {1}_{3} ) , P ( g {2}_{i} \vert {b}_{j} ⋂ g {1}_{4} ) & ( 11 ) \\ {CPM}_{G 2 amplified} : \\ ( \begin{matrix}0.95 & … & 0.95 & 0.5 & … & 0.5 & 0.475 & … & 0.475 & 0.475 & … & 0.475 \\ 0.05 & … & 0.05 & 0.5 & … & 0.5 & 0.025 & … & 0.025 & 0.025 & … & 0.025 \\ 0 & … & 0 & 0 & … & 0 & 0.475 & … & 0.475 & 0.475 & … & 0.475 \\ 0 & … & 0 & 0 & … & 0 & 0.025 & … & 0.025 & 0.025 & … & 0.025\end{matrix} ) & ( 12 ) \\ {CPM}_{G 1 out amplified} \text{:} ( \begin{matrix}1 & 0 & 0 & 0 & 1 & 0 & 0 & 0 & 1 & 0 & 0 & 0 & 1 & 0 & 0 & 0 \\ 0 & 1 & 0 & 0 & 0 & 1 & 0 & 0 & 0 & 1 & 0 & 0 & 0 & 1 & 0 & 0 \\ 0 & 0 & 1 & 0 & 0 & 0 & 1 & 0 & 0 & 0 & 1 & 0 & 0 & 0 & 1 & 0 \\ 0 & 0 & 0 & 1 & 0 & 0 & 0 & 1 & 0 & 0 & 0 & 1 & 0 & 0 & 0 & 1\end{matrix} ) & ( 13 ) \\ \begin{matrix}0.905 & 0.05 & 0 & 0 & 0.5 & 0.05 & 0 & 0 \\ 0.095 & 0.95 & 0 & 0 & 0.5 & 0.95 & 0 & 0 \\ 0 & 0 & 0.905 & 0.05 & 0 & 0 & 0.5 & 0.05 \\ 0 & 0 & 0.095 & 0.95 & 0 & 0 & 0.5 & 0.95\end{matrix} & ( 14 ) \\ \begin{matrix}0.4525 & 0.025 & 0 & 0 & 0.4525 & 0.025 & 0 & 0 \\ 0.0475 & 0.475 & 0 & 0 & 0.0475 & 0.475 & 0 & 0 \\ 0.4525 & 0.025 & 0.905 & 0.05 & 0.0475 & 0.025 & 0.5 & 0.05 \\ 0.0475 & 0.475 & 0.095 & 0.95 & 0.4525 & 0.475 & 0.5 & 0.95\end{matrix} & ( 15 ) \\ P ( {b}_{i} ⋂ g {1}_{k} ) = P ( g {1}_{k} \vert {b}_{i} ) \cdot P ( {b}_{i} ) & ( 16 ) \\ {SPR}_{G 4 ik} = ( {ITM}_{OR}^{T} \cdot ( {SPR}_{G 1 ik amplified} ⊗ {SPR}_{G 3 ik} ) \cdot {PTM}_{OR} ) \cdot ( P ( g {1}_{k} \vert {b}_{i} ) \cdot P ( {b}_{i} ) ) & ( 17 ) \\ {SPR}_{G 4} = ( \begin{matrix}0.5149 & 0.1101 \\ 0.0345 & 0.3405\end{matrix} ) & ( 18 ) \\ R = {SPR}_{G 4} ( 0 , 0 ) + {SPR}_{G 4} ( 1 , 1 ) = 0.5149 + 0.3405 = 0.8554 . & ( 19 )\end{matrix}$$

Annexe 4

```
  SPR_final(1,1)=0 ;
  SPR_final(1,2)=0 ;
  SPR_final(2,1)=0 ;
  SPR_final(2,2)=0 ;
  for j=1:4
  e=e_j;
  for k=1:4
  f=f_k;
  for 1=1:4
  d=d_1;
SPR_aux=(ITM_T)*(kronecker_product
(SPR_E(j),SPR_I(j,k,l), SPR_H(1))*PTM ;
  weight=0 ;
  for m=1:4
  i1=i1_m ;
  for n=1:4
  i2=i2_n ;
  for o=1:4
  i3=i3_o ;
  for q=1:4
  i4=i4_q;
  weight=weight+(e_j|i1_m,i2_n,f_k)*(f_k|i1_m, i2_n,i3_o,
i4_q)
  * (d_l|i3_o,i4_q)*i1_m*i2_n*i3_o*i4_q;
  end;
  end;
  end;
  end;
  SPR_final=DPR_final+SPR_aux*weight;
  end;
  end;
  end;
```

1-28. (canceled)

29. A method for estimating reliability of an electronic circuit comprising a network of interconnected nodes at least some of which comprise placed components, the electronic circuit comprising at least one path comprising a correlation source, a plurality of branches starting at a level of the correlation source, and a component forming a sink where the branches culminate, the method comprising:
performing a global processing based on a probabilistic propagation approach using matrix representations of probabilities associated with states of signals present at least some of the nodes of the network of interconnected nodes and matrix representations of transfers of signals through the placed components; and
making a determination of a reliability guideline resulting from the global processing,
the global processing comprising, for each component of the path, performing a local processing, the local processing comprising performing a computation of at least one conditional probability matrix containing probabilities of various states of a signal present at the component, conditioned by various states of at least one signal present at the component or at least one node situated on the path upstream of the component, so as to determine the reliability guideline based upon signals which are one of independent and rendered independent, despite a presence of the correlation sources.

30. A method according to claim 29, wherein the electronic circuit comprises at least one input node; and wherein performing the global processing comprises a performing a computation at each input node of an input matrix containing the probabilities of various states of an input signal received at that node, local processings of a matrix type associated with the components, and involving local probability input matrices, probabilistic transfer matrices, and ideal transfer matrices for the components.

31. A method according to claim 30, wherein, at the component forming the sink, at least two signals are mutually correlated by at least one correlation source; and wherein the local processing comprises, for each correlated signal, performing a computation of a conditional probability matrix containing probabilities of various states of the correlated signal, conditioned by various states of at least one signal delivered by the at least one correlation source from which the correlated signal arises.

32. A method for estimating reliability of an electronic circuit comprising a nodal network comprising at least one input node, at least one output node, and a plurality of components forming intermediate nodes interconnected between the at least one input node and the at least one output node, the method, implemented within a computerized system, comprising:
performing a global processing based on a probabilistic propagation approach using matrix representations of probabilities of states of signals present at various nodes and matrix representations of transfer of signals through the plurality of components; and
determining a reliability guideline at a level of the at least one output node resulting from the global processing, such that in a presence at a level of at least one of the components of at least two signals mutually correlated by at least one node forming at least one correlation source, a probability matrix representation associated with each correlated signal comprises a conditional probability matrix containing probabilities of various states of the correlated signal, conditioned by states of at least one signal delivered by at least one correlation source from which the correlated signal arises, so as to determine the reliability guideline based upon signals which are independent or rendered independent, despite a presence of correlation sources.

33. A method according to claim 32, wherein performing the global processing comprises performing a computation at a level of each input node of an input matrix containing probabilities of various states of an input signal received at that node, local processings of a matrix type associated with the components and involving local probability input matrices, probabilistic matrixes, and ideal transfer matrices for the components; and wherein the local processing associated with a component receiving the at least two correlated signals comprises for each of the correlated signals, determining a corresponding conditional probability matrix.

34. A method according to claim 32, further comprising performing an analysis of the nodal network of the electronic circuit so as to determine a correlation source, a path starting at a level of the correlation source, and a sink at which the path culminate, each component of the sink receiving as input a plurality of correlated signals.

35. A method according to claim 34, wherein performing the local processing associated with a component forming a sink comprises, for each of the correlated signals feeding this sink, determining a conditioned matrix containing probabilities of various states of the correlated signal, conditioned by various states of the signal delivered by at least one of the correlation sources feeding this sink.

36. A method according to claim 35, wherein the correlated signals feeding the sink are correlated by a set of correlation sources; and wherein performing the determination of the conditioned local input matrix associated with each of the correlated signals feeding the sink comprises, when a conditioned initial matrix associated with a given correlated signal is conditioned at least some of the correlation sources, a modification of the conditioned matrix made so as to obtain a conditioned modified matrix for the correlation sources.

37. A method according to claim 36, wherein the modified matrix comprises a number of copies of each column of the conditioned initial matrix equal to a number of possible states of the signals delivered by correlation sources not taken into account in the conditioned initial matrix.

38. A method according to claim 35, wherein each correlated signal feeding the said sink is correlated a same correlation source; and wherein determining the conditioned local input matrix associated with each of the correlated signals feeding the sink comprises, when a conditioned initial matrix associated with this correlated signal is not conditioned to the correlation source, modifying the conditioned initial matrix so as to render it conditioned to the correlation source.

39. A method according to claim 37, wherein modifying the conditioned initial matrix comprises performing a matrix multiplication of conditioned local output matrices of the components coupled between the sink and the correlation source.

40. A method according to claim 35, wherein the nodal network of the electronic circuit comprises at least one primary correlation source and at least one secondary correlation source, the at least one primary correlation source comprising a source from which at least one path starts, the at least one secondary correlation source comprising a source from which at least one path starts and belonging to a path fed by a previous correlation source, placed upstream of the at least one secondary correlation source; and wherein the local processing of a component forming a secondary correlation source comprises performing a computation of a conditioned local output matrix equal to an identity matrix of a conditioned auxiliary matrix containing probabilities of various states of a local output signal delivered by the at least one secondary source, conditioned by various states of signals delivered by the correlation sources situated upstream of the at least one secondary correlation source and linked thereto, the conditioned local output matrix being used as a conditioned local input matrix for a component situated downstream of the at least one secondary correlation source and linked directly to the at least one secondary correlation source.

41. A method according to claim 34, wherein the local processing associated with a component forming a sink comprises, for each of the correlated signals feeding an input of this sink, determining a conditioned matrix containing probabilities of various states of the correlated signal, conditioned by various states of the signal delivered by a closest correlation source coupled to the input of the sink.

42. A method according to claim 41, wherein the nodal network of the electronic circuit comprises at least one primary correlation source and at least one secondary correlation source, the at least one primary correlation source being a source from which at least one path starts, the at least one secondary correlation source being a source from which at least one path starts and belonging to a path fed by a previous correlation source placed upstream of the at least one secondary correlation source, and the local processing of a component forming the at least one secondary source comprises computing a conditioned local output matrix equal to an identity matrix of a conditioned auxiliary matrix containing probabilities of various states of a local output signal delivered by this secondary source, conditioned by various states of signals delivered by correlation sources situated upstream of this secondary source and closest to this secondary source, and linked to this secondary source, and a conditioned local output matrix is used as a conditioned local input matrix for a component situated downstream of this secondary source on a path and linked directly to this secondary source.

43. A method according claim 34, wherein the local processing associated with a component situated on at least one path and forming neither a correlation source nor a sink comprises computing a local output matrix conditioned by components situated upstream of the component the at least one path, based upon conditioned matrices containing respectively probabilities of various states of signals delivered by these upstream components conditioned by various states of these same signals.

44. A method according to claim 34, wherein the local processing associated with an internal sink forming an intermediate node of another path comprises computing, based upon conditioned local input matrices associated with this internal sink, a conditioned local output matrix containing probabilities of various states of local output signal of this internal sink, conditioned by various states of signals conditioning conditioned local input matrices of this internal sink.

45. A method according claim 34, wherein the local processing associated with a final sink not comprises computing a conditioned local output matrix based upon conditioned local input matrices associated with this final sink and weighting elements of a conditioned local output matrix by the probabilities of various states of signals delivered by correlation sources linked to this final sink.

46. A method according to claim 45, wherein at least some of the probabilities used in the weighting are elements of the conditioned auxiliary matrix.

47. A method according to claim 45, wherein each input matrix associated with an input node of the electronic circuit has an input size, and the weighting is applied to columns of values of the conditioned output matrix of the final sink; and wherein the local processing of the final sink furthermore comprises computing a local output matrix having the input size based upon a result of the weighting.

48. A method according to claim 45, wherein each input matrix associated with an input node of the electronic circuit has an input size, and a conditioned matrix associated with a component based upon a first matrix having the input size, and an initial conditioned matrix, is determined by:
transforming of each column of an initial conditioned matrix into a first intermediate matrix having the input size,
for each first intermediate matrix, determining a matrix product involving transpose of an ideal transfer matrix of the component, a probabilistic transfer matrix of this component and a Kronecker product of the initial matrix and the first intermediate matrix, each matrix product providing a second intermediate matrix;
transforming each second intermediate matrix into a column vector to thereby generate the conditioned matrix.

49. A method according to claim 45, wherein each input matrix associated with an input node of the electronic circuit has an input size, and a conditioned matrix associated with a component based upon a first initial conditioned matrix and a second initial conditioned matrix, is determined by:
transforming each column of the first initial conditioned matrix into a first intermediate matrix having the input size;
transforming each column of the second initial conditioned matrix into a second intermediate matrix having the input size;
for each first intermediate matrix and for each homologous second intermediate matrix, calculating a matrix product involving a transpose of an ideal transfer matrix of the component, a probabilistic transfer matrix of this component, and a Kronecker product of the first intermediate matrix and the second intermediate matrix, each matrix product providing a third intermediate matrix, and transforming each third intermediate matrix into a column vector to thereby generate the conditioned matrix.

50. A method according to claim 34, wherein the local processings are performed in a recursive manner from outputs to inputs of the electronic circuit.

51. A method according to claim 32, wherein the plurality of components comprise combinatorial elements, input signals of the electronic circuit and output signals of the electronic circuit being logic signals able to take at least one of a first logic value and a second logic value, an input matrix associated with a given input signal, an output matrix associated with a given output signal being an elementary matrix having 2×2 input size and comprising a probability that the first logic value is a correct value corresponding to a first state, a probability that the second logic value is an incorrect value corresponding to a second state, a probability that the first logic value is an incorrect value corresponding to a third state, and a probability that the second logic value is a correct value corresponding to a fourth state.

52. A method according to claim 51, wherein each elementary matrix is arranged such that that a first column of that elementary matrix contains the probability associated with the first state and the probability associated with the third state, a second column of that elementary matrix containing the probability associated with the second state and the probability associated with the fourth state, a diagonal of that elementary matrix containing the probability associated with the first state and the probability associated with the fourth state; and wherein a conditioned matrix associated with a signal is arranged such that a column of the conditioned matrix contains the probabilities of the first, second, third, and fourth states respectively conditioned by at least one conditioning signal, two non-duplicated columns of the conditioned matrix being respectively associated with two states of the at least one conditioning signal.

53. A method according to claim 51, wherein the nodal network comprises at least one output node at a level of which an output matrix associated with an output signal is computed; and wherein the determination of the reliability guideline comprises a sum of the probabilities of the output matrix of the output signals of the electronic circuit which are associated respectively with the states corresponding to correct values of the output signal.

54. An electronic device for estimating reliability of an electronic circuit comprising a nodal network comprising at least one input node, at least one output node, and a plurality of components forming intermediate nodes interconnected between the at least one input node and the at least one output node, the electronic device comprising:
a memory;
a processor coupled to the memory and configured to
perform a global processing based on a probabilistic propagation approach using matrix representations of probabilities of states of signals present at various nodes and matrix representations of transfer of signals through the plurality of components, and
determine a reliability guideline at a level of the at least one output node resulting from the global processing, such that in a presence at a level of at least one of the components of at least two signals mutually correlated by at least one node forming at least one correlation source, probability matrix representation associated with each correlated signal comprises a conditional probability matrix containing probabilities of various states of the correlated signal, conditioned by states of at least one signal delivered by at least one correlation source from which the correlated signal arises, so as to determine the reliability guideline based upon signals which are independent or rendered independent, despite a presence of correlation sources.

55. An electronic device according to claim 54, wherein the processor performs the global processing by performing a computation at a level of each input node of an input matrix containing probabilities of various states of an input signal received at that node, local processings of a matrix type associated with the components and involving local probability input matrices, probabilistic matrixes, and ideal transfer matrices for the components; and wherein the local processing associated with a component receiving the at least two correlated signals comprises for each of the correlated signals, determining a corresponding conditional probability matrix.

56. An electronic device according to claim 54, wherein the processor is also configured to perform an analysis of the nodal network of the electronic circuit so as to determine a correlation source, a path starting at a level of the correlation source, and a sink at which the path culminate, each component of the sink receiving as input a plurality of correlated signals.

57. An electronic device according to claim 56, wherein the processor performs the local processing associated with a component forming a sink by, for each of the correlated signals feeding this sink, determining a conditioned matrix containing probabilities of various states of the correlated signal, conditioned by various states of the signal delivered by at least one of the correlation sources feeding this sink.

58. An electronic device according to claim 57, wherein the correlated signals feeding the sink are correlated by a set of correlation sources; and wherein the processor performs the determination of the conditioned local input matrix associated with each of the correlated signals feeding the sink by, when a conditioned initial matrix associated with a given correlated signal is conditioned at least some of the correlation sources, modifying the conditioned matrix so as to obtain a conditioned modified matrix for the correlation sources.

59. An electronic device according to claim 58, wherein the modified matrix comprises a number of copies of each column of the conditioned initial matrix equal to a number of possible states of the signals delivered by correlation sources not taken into account in the conditioned initial matrix.

60. A non-transitory computer readable medium containing computer executable instructions that, when executed, cause the computer to at least:
perform a global processing based on a probabilistic propagation approach using matrix representations of probabilities of states of signals present at various nodes and matrix representations of transfer of signals through the plurality of components, and
determine a reliability guideline at a level of the at least one output node resulting from the global processing, such that in a presence at a level of at least one of the components of at least two signals are mutually correlated by at least one node forming at least one correlation source, a probability matrix representation associated with each correlated signal comprises a conditional probability matrix containing probabilities of various states of the correlated signal, conditioned by states of at least one signal delivered by at least one correlation source from which the correlated signal arises, so as to determine the reliability guideline based upon signals which are independent or rendered independent, despite a presence of correlation sources.

61. A non-transitory computer readable medium according to claim 60, wherein performing the global processing comprises performing a computation at a level of each input node of an input matrix containing probabilities of various states of an input signal received at that node, local processings of a matrix type associated with the components and involving local probability input matrices, probabilistic matrixes, and ideal transfer matrices for the components; and wherein the local processing associated with a component receiving the at least two correlated signals comprises for each of the correlated signals, determining a corresponding conditional probability matrix.

62. A non-transitory computer readable medium according to claim 60, further comprising performing an analysis of the nodal network of the electronic circuit so as to determine a correlation source, a path starting at a level of the correlation source, and a sink at which the path culminate, each component of the sink receiving as input a plurality of correlated signals.

63. A method non-transitory computer readable medium to claim 62, wherein performing the local processing associated with a component forming a sink comprises, for each of the correlated signals feeding this sink, determining a conditioned matrix containing probabilities of various states of the correlated signal, conditioned by various states of the signal delivered by at least one of the correlation sources feeding this sink.

64. A method non-transitory computer readable medium to claim 63, wherein the correlated signals feeding the sink are correlated by a set of correlation sources; and wherein performing the determination of the conditioned local input matrix associated with each of the correlated signals feeding the sink comprises, when a conditioned initial matrix associated with a given correlated signal is conditioned at least some of the correlation sources, a modification of the conditioned matrix made so as to obtain a conditioned modified matrix for the correlation sources.

65. A method non-transitory computer readable medium to claim 64, wherein the modified matrix comprises a number of copies of each column of the conditioned initial matrix equal to a number of possible states of the signals delivered by correlation sources not taken into account in the conditioned initial matrix.
